(19) United States
(12) Patent Application Publication
(10) Pub. No.: US 2020/0081398 A1
(43) Pub. Date: Mar. 12, 2020

(54) PHOTOSENSITIVE POLYMERS FOR VOLUME HOLOGRAPHY

(71) Applicant: FACEBOOK TECHNOLOGIES, LLC, Menlo Park, CA (US)

(72) Inventor: Oleg YAROSHCHUK, Redmond, WA (US)

(21) Appl. No.: 16/443,506

(22) Filed: Jun. 17, 2019

Related U.S. Application Data
(60) Provisional application No. 62/728,053, filed on Sep. 6, 2018.

(51) Int. Cl. G03H 1/02; C08L 101/08

(52) U.S. Cl. CPC G03H 1/0248; C08L 101/08; G03H 2270/14; G03H 2250/12; G03H 2260/12; G03H 2001/0264

(57) ABSTRACT

Photosensitive polymers for recording volume holograms, anisotropic volume holograms, and corresponding volume holographic elements are described herein.

### RELATED APPLICATIONS

This application claims the benefit of, and priority to, U.S. Provisional Patent Application Ser. No. 62/728,053, filed Sep. 6, 2018, which is incorporated by reference herein in its entirety. This application is related to U.S. patent application Ser. No. 16/273,068, filed Feb. 11, 2019, which claims the benefit of, and priority to, U.S. Provisional Patent Application Ser. No. 62/659,104, filed Apr. 17, 2018 and U.S. Provisional Patent Application Ser. No. 62/728,053, filed Sep. 6, 2018. All of these applications are incorporated by reference herein in their entireties.

### FIELD OF THE INVENTION

The invention described herein relates generally to recording materials for volume holographic gratings, volume holograms, volume holographic elements, and photosensitive polymers for use in volume holography applications as well as the volume holographic gratings, volume holograms, volume holographic elements produced through writing to such recording materials.

### BACKGROUND

Polarization volume holographic elements (also called herein polarization volume holograms) have gained increasing interest for applications in optics, such as beam steering devices, waveguides, and display technologies. Conventionally, polarization volume holographic elements were made by using a photoalignment layer. For example, the photoalignment layer includes directional molecules arranged in a particular pattern, and liquid crystals are deposited on the photoalignment layer so that the liquid crystals are aligned along the direction of the directional molecules. However, when the photoalignment layer is used, liquid crystals can be arranged in only certain three-dimensional configurations (e.g., only in the plane defined by the photoalignment layer).

### SUMMARY

One embodiment of the invention relates to a recording material for a volume hologram, wherein the recording material is characterized by a thickness and includes a compound including a moiety of Formula 1:

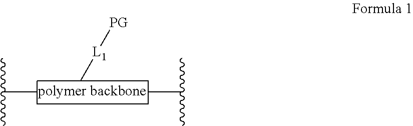

wherein the moiety of Formula 1 includes a polymer backbone, and a side chain including a linker L₁ and a photosensitive group PG. In some embodiments, the moiety of Formula 1 further includes a terminal group T₁ as in Formula 2:

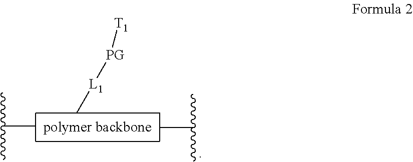

In some embodiments, the photosensitive group includes a cycloaddition precursor (CAP). In some embodiments, the photosensitive group includes a cinnamate moiety. In some embodiments, the linker L₂ includes one or more of a single bond, a double bond, a triple bond, a carbonyl group, a carboxyl group, a methylene group, an ether group, and an optionally substituted phenylene group. In some embodiments, the terminal group T₁ includes one or more of a single bond, a double bond, a triple bond, an optionally substituted phenylene group, a carbonyl group, a carboxyl group, a methylene group, an ether group, —H, —OH, —CH₃, —N(CH₃)₂, —C₂H₅, —C₃H₇, —CN, —NO₂, —OCH₃, —OC₂H₅, and —OC₃H₇. In some embodiments, the phenylene group is a 1,4-phenylene group. In some embodiments, the polymer backbone includes a homopolymer fragment or a copolymer fragment. In some embodiments, the polymer backbone includes one or more of a polysiloxane fragment, a polymethylmethacrylate (PMMA) fragment, a polyacrylate fragment, a polymethacrylate fragment, a cellulose fragment, a polyvinyl fragment, a polyurethane fragment, a polyamic acid fragment, or a polyimide fragment.

Another embodiment of the invention relates to a recording material for a volume hologram, where the recording material is characterized by a thickness and includes a compound including a moiety of Formula 1, wherein the moiety of Formula 1 includes a polymer backbone, and a side chain, wherein the side chain is of any one of Formulas 101 to 105:

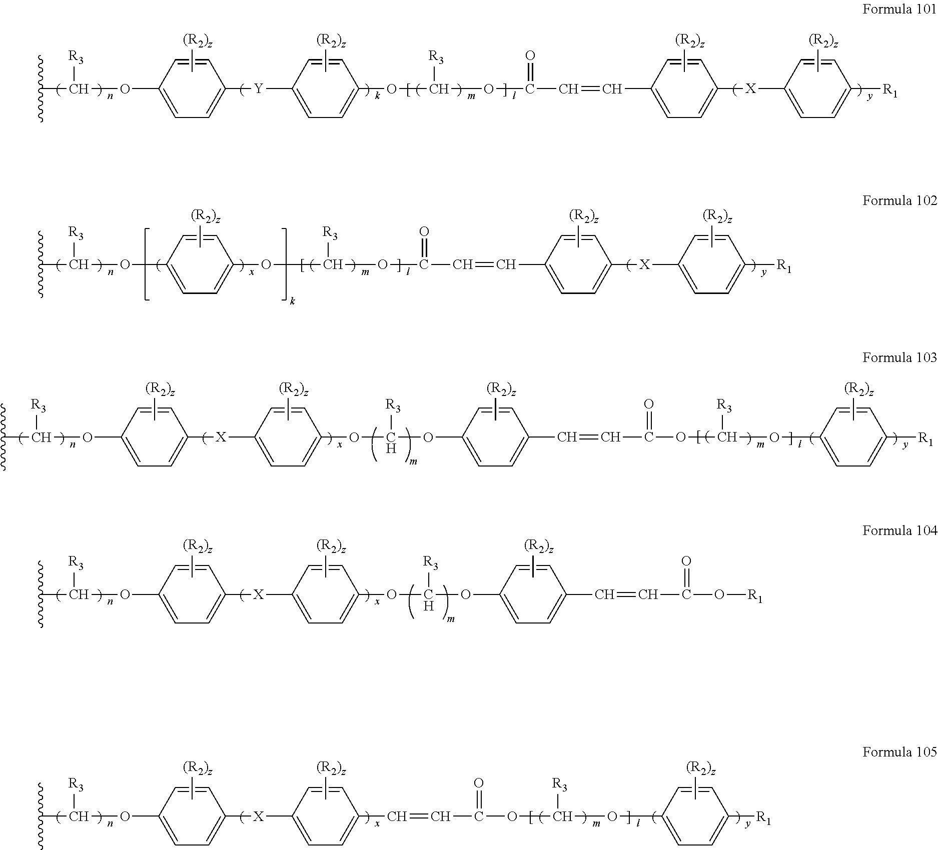

wherein in Formulas 101 to 105: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; X and Y are independently selected from a single bond, a double bond, a triple bond, —C(O)—, —C(O)O—, —OC(O)—, and —C(O)NR^{a}; R₁ is independently selected from —H, —OH, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, where the recording material is characterized by a thickness and includes a compound including a moiety of Formula 1, wherein the moiety of Formula 1 includes a polymer backbone, and a side chain, wherein the side chain is of any one of Formulas 106 to 117:

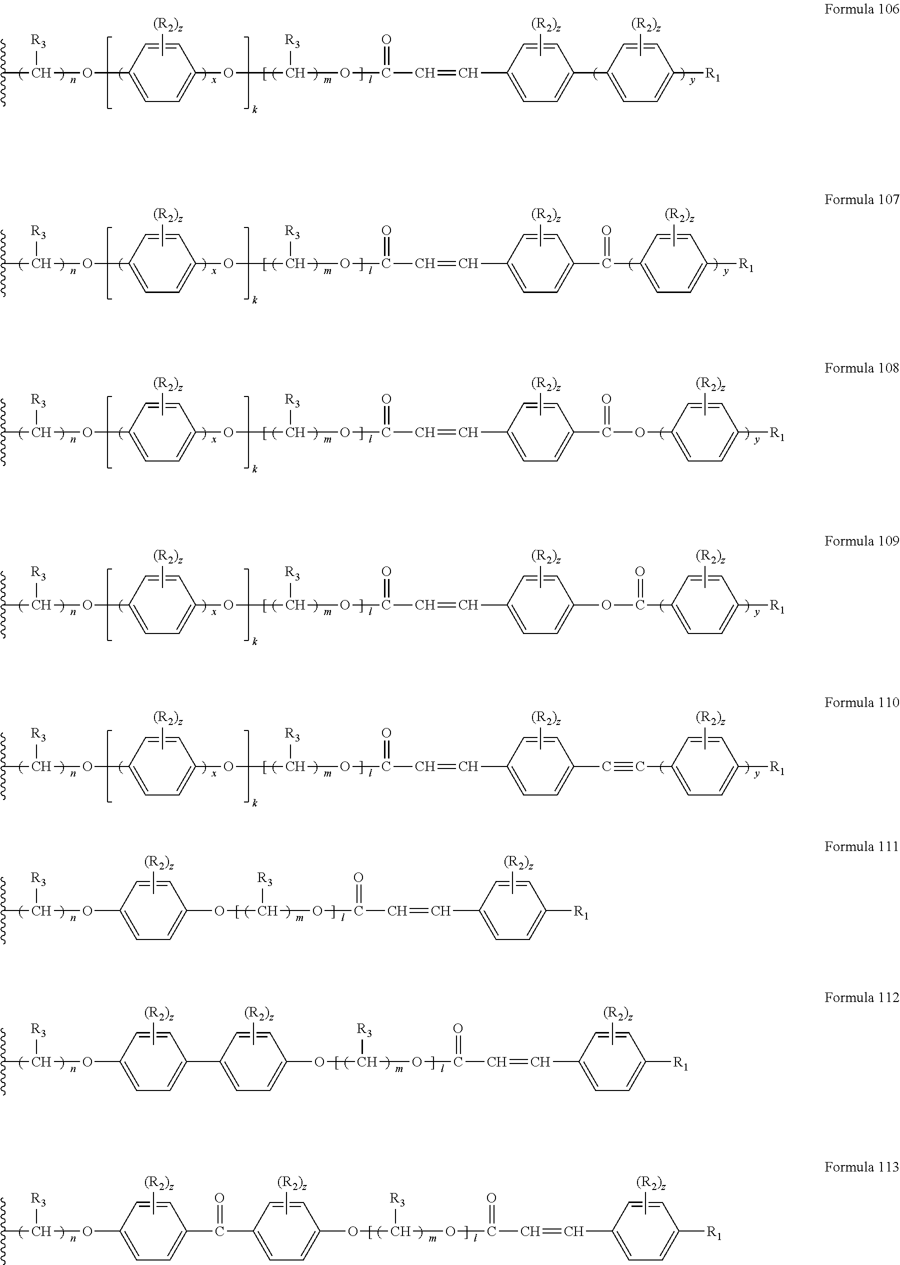

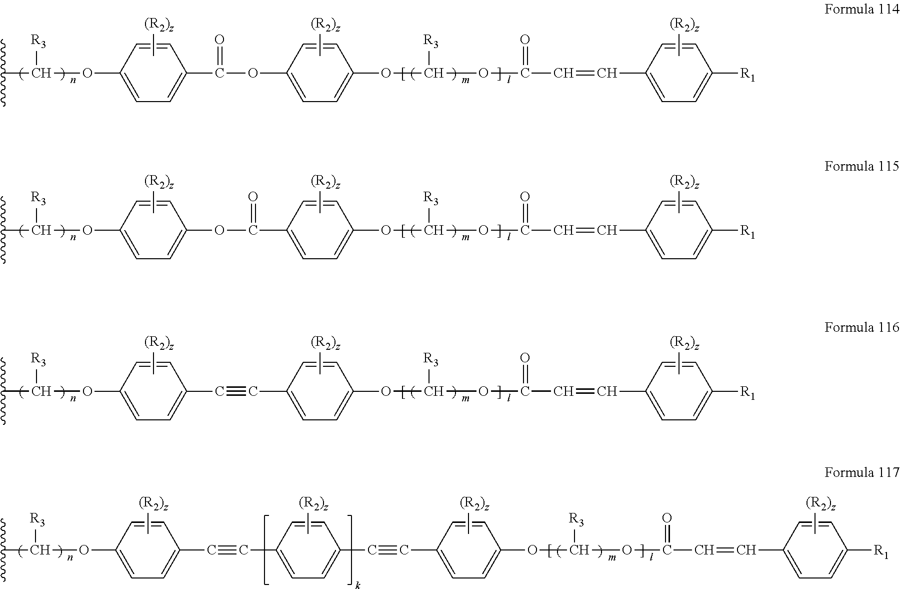

wherein in Formulas 106 to 117: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; R₁ is independently selected from —H, —OH, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 118 to 123:

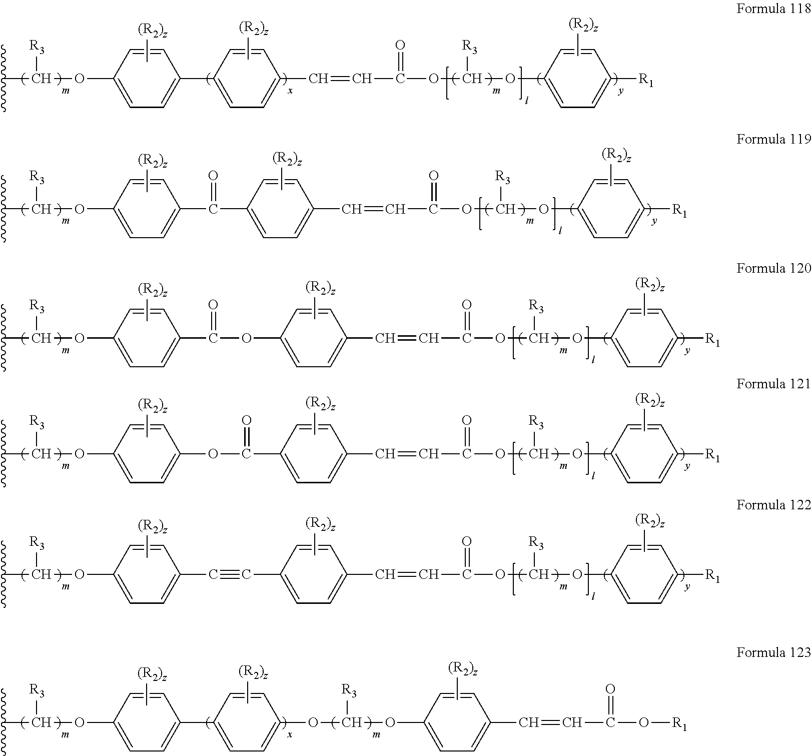

wherein in Formulas 118 to 123: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; R₁ is independently selected from —H, —OH, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 124 to 131:

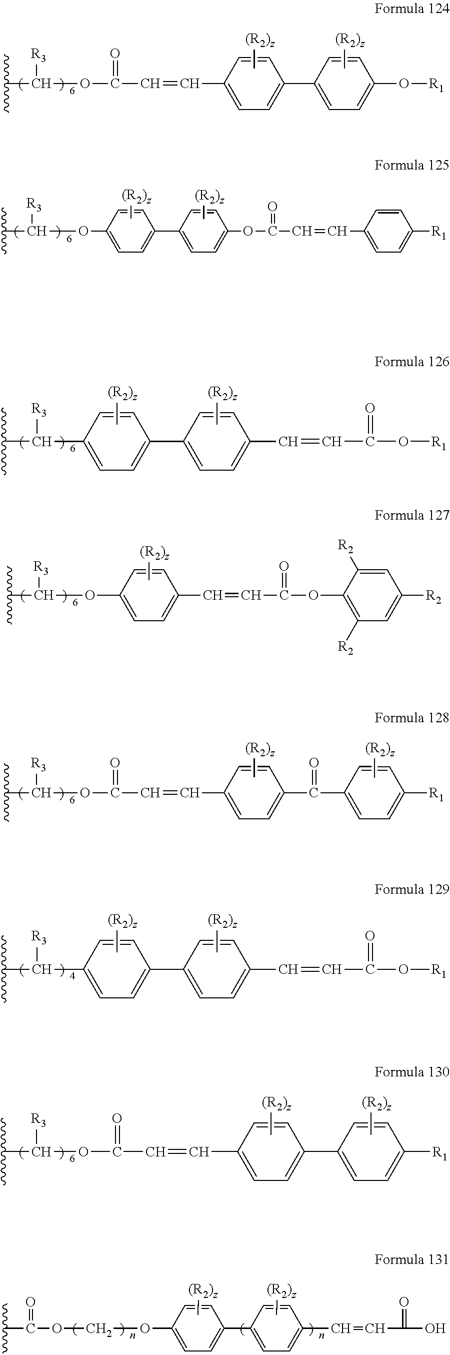

wherein in Formulas 124 to 131: z is independently at each occurrence 0, 1, 2, 3, or 4; n is independently an integer from 0 to 12; m is independently 0 or 1;

R₁, R₂, and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 1001 to 1011:

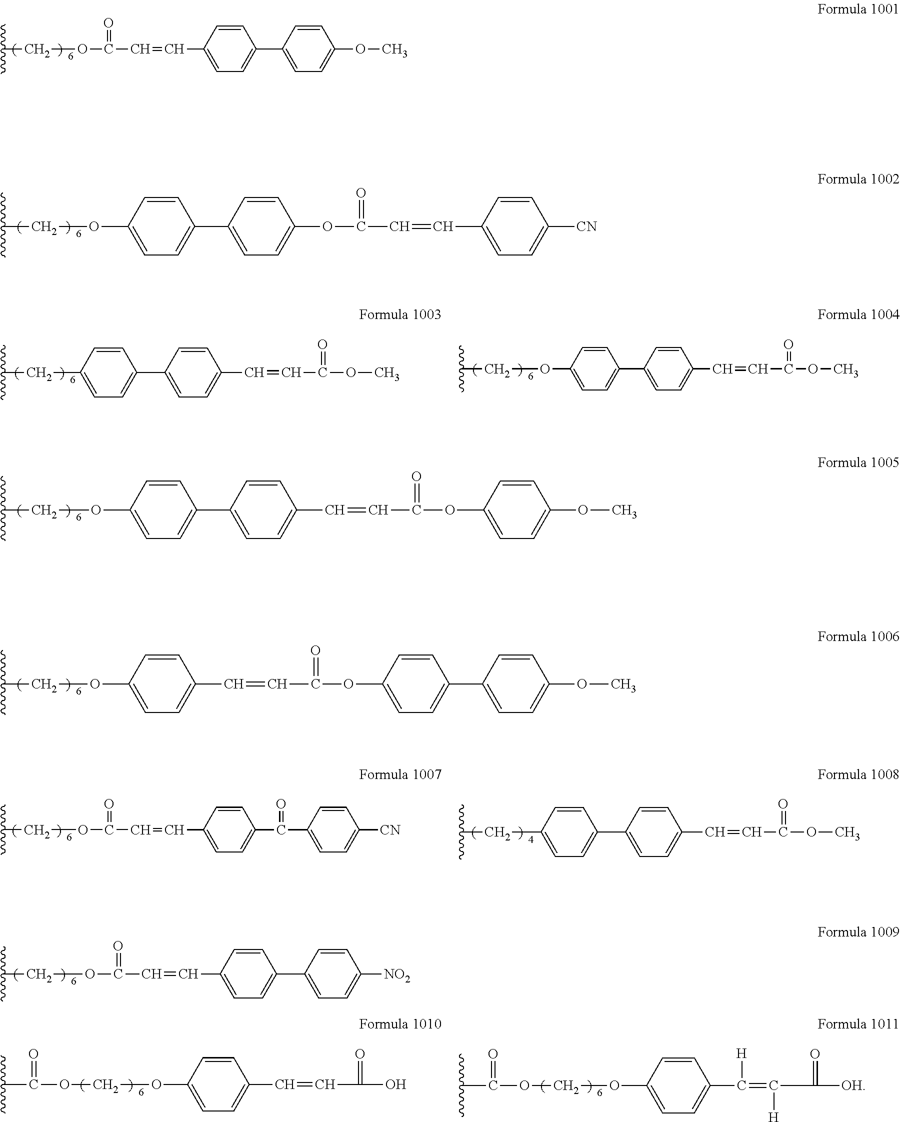

Another embodiment of the invention relates to a recording material for a volume hologram, wherein the recording material is characterized by a thickness and includes a compound including a moiety of Formula 1, wherein the moiety of Formula 1 is of any one of Formulas 2001 to 2014:

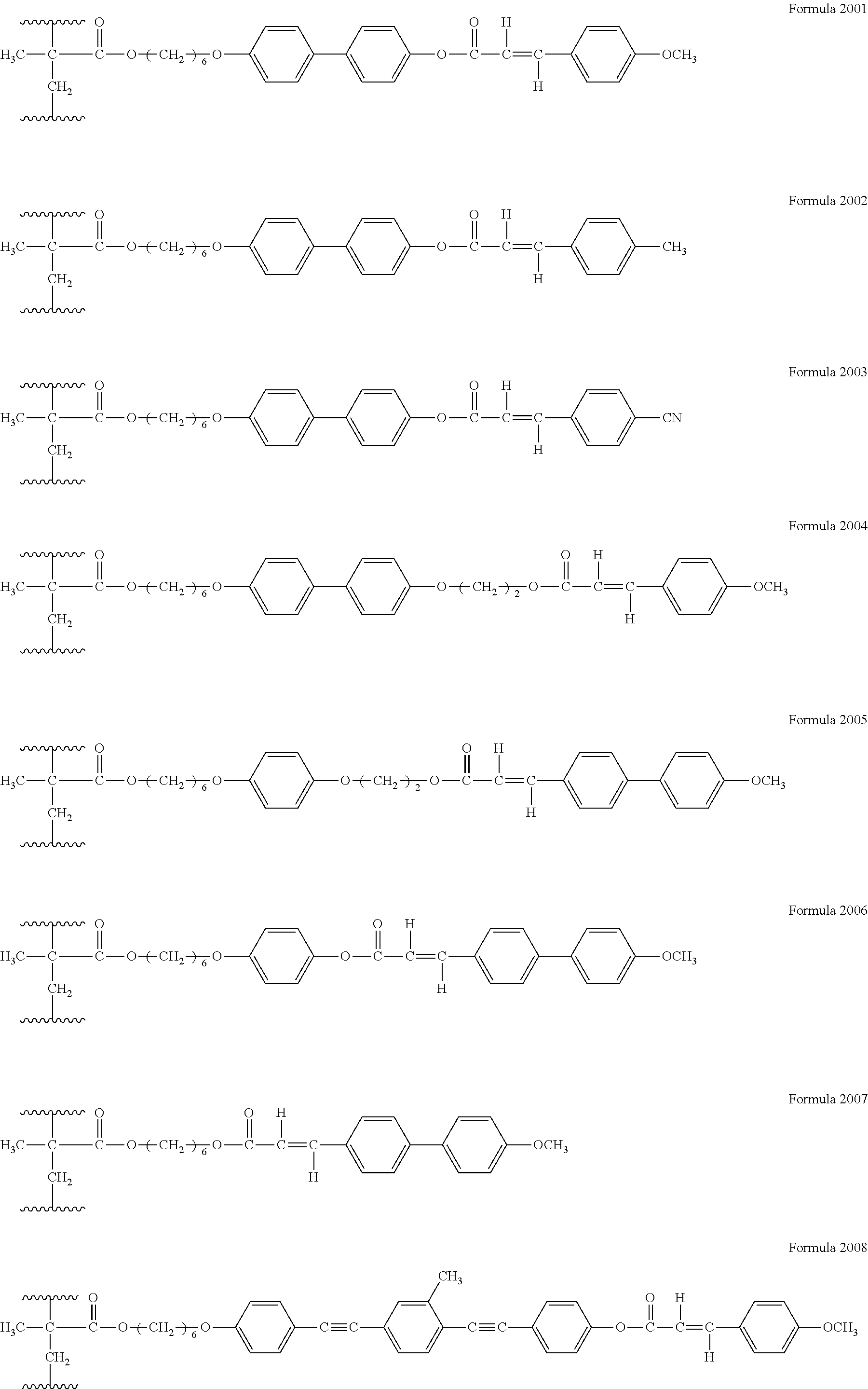

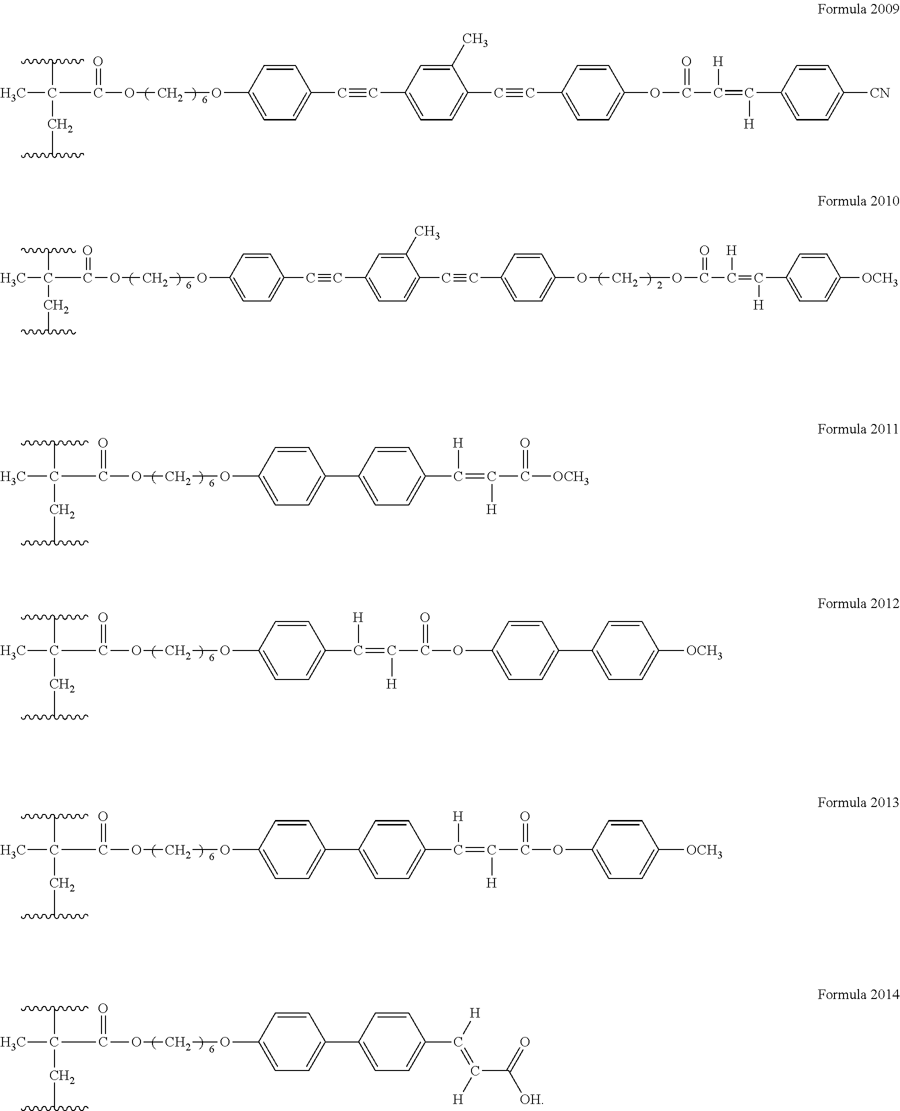

Another embodiment of the invention relates to a recording material for a volume hologram, wherein the recording material is characterized by a thickness and includes a compound including a moiety of Formula 1, wherein a volume hologram is recorded in the recording material and is characterized by a Q parameter that is equal to or greater than 10, wherein

$$Q = \frac{2 π λ d}{n {Λ}^{2}} ,$$

and wherein: λ is a wavelength of diffracting light, d is the thickness of the volume hologram, n is an averaged refractive index of the recording material for a wavelength λ, and Λ is a grating period (fringe spacing) of the volume hologram.

Another embodiment of the invention relates to a recording material for a volume hologram, wherein a volume hologram is recorded in the recording material and is characterized by a thickness and includes a compound including a moiety of Formula 1, wherein the volume hologram is characterized by a Q parameter that is equal to or greater than 5, wherein

$$Q = \frac{2 π λ d}{n {Λ}^{2}} ,$$

and wherein: λ is a wavelength of diffracting light, d is the thickness of the volume hologram, n is an averaged refractive index of the recording material for a wavelength λ, and Λ is a grating period (fringe spacing) of the volume hologram. In some embodiments, the thickness of the volume hologram is between 0.05 μm and 500 μm. In some embodiments, the recording material is liquid crystalline, and the thickness of the volume hologram is between 0.05 μm and 500 μm. In some embodiments, the recording material has liquid crystal property, and the thickness of the volume hologram is between 0.05 μm and 500 μm. In some embodiments, the recording material is amorphous and a thickness of the volume hologram is between 0.05 m and 500 μm. In some embodiments, the thickness of the volume hologram is between 0.5 m and 1000 m. In some embodiments, the recording material is liquid crystalline, and the thickness of the volume hologram is between 0.5 m and 1000 m. In some embodiments, the recording material has liquid crystal property, and the thickness of the volume hologram is between 0.5 m and 1000 m. In some embodiments, the recording material is amorphous and a thickness of the volume hologram is between 0.5 m and 1000 m. In some embodiments, the thickness of the volume hologram is between 1 m and 2500 m. In some embodiments, the recording material is liquid crystalline, and the thickness of the volume hologram is between 1 m and 2500 m. In some embodiments, the recording material has liquid crystal property, and the thickness of the volume hologram is between 1 m and 2500 m. In some embodiments, the recording material is amorphous and a thickness of the volume hologram is between 1 m and 2500 m.

Another embodiment of the invention relates to a recording material for a volume hologram, wherein the recording material is characterized by a thickness and includes a compound including a moiety of Formula 1, wherein: the recording material is characterized by induced birefringence of greater than 0.002, greater than 0.04, or greater than 0.10. In some embodiments, the material is optically transparent to visible light.

Another embodiment of the invention relates to a recording material for a volume hologram, wherein the recording material is characterized by a thickness and includes a compound including a moiety of Formula 1, wherein: the recording material is amorphous and characterized by induced birefringence of greater than 0.002.

Another embodiment of the invention relates to a recording material for a volume hologram, wherein the recording material is characterized by a thickness and includes a compound including a moiety of Formula 1, wherein the recording material is liquid crystal or amorphous polymer. In some embodiments, the compound aligns parallel in relation to the substrate. In some embodiments, the compound aligns homeotropically in relation to the substrate. In some embodiments, the compound is arranged in tilted alignment in relation to the substrate. In some embodiments, the compound is arranged in twisted alignment.

Another embodiment of the invention relates to a recording material for a volume hologram, wherein the recording material is characterized by a thickness and includes a compound including a moiety of Formula 1, and wherein a volume hologram in the recording material is a polarization grating.

Another embodiment of the invention relates to a recording material for a volume hologram, wherein a volume hologram recorded in the recording material is characterized by a thickness and includes a compound including a moiety of Formula 1, and wherein the volume hologram is an intensity grating.

Another embodiment of the invention relates to a process for writing a data structure including information into a recording material, thereby forming a volume hologram, wherein the recording material for the volume hologram is characterized by a thickness and includes a compound including a moiety of Formula 1, the process including: orienting a coherent light source toward the recording material; and cross-linking through a cycloaddition reaction a portion of the total number of photosensitive groups in the recording material using the coherent light source; wherein the information of the data structure is stored in the form of selective cross-linking of the photosensitive groups in a pattern corresponding to the information. In some embodiments, the writing results in between two percent and thirty percent of the photosensitive groups of the recording material being cross-linked. In some embodiments, the writing results in between three percent and twenty percent of the photosensitive groups of the recording material being cross-linked.

In some embodiments, the coherent light source includes: a first incident light beam and a second incident light beam originating from the coherent light source, where the beams partially or completely overlap and interfere in recording material. In some embodiments, the incident light beams are linearly polarized and their polarization directions are parallel. In some embodiments, the incident light beams are linearly polarized and their polarization directions are perpendicular. In some embodiments, the first incident light beam is circularly polarized in a first direction, and the second incident light beam is circularly polarized in the first direction. In some embodiments, the first incident light beam is circularly polarized in a first direction, and the second incident light beam is circularly polarized in an opposite (orthogonal) direction. In one embodiment, the first incident light beam and the second incident light beam impinge upon the same surface of a recording layer. In another embodiment, the first incident light beam and the second incident light beam impinge upon opposite surfaces of a recording layer.

In some embodiments, the writing results in between four percent and fifteen percent of the photosensitive groups being cross-linked. In some embodiments, the writing results in between four percent and fifteen percent of the photosensitive groups being cross-linked. In some embodiments, the writing results in about five percent, or about six percent, or about seven percent, or about eight percent, or about nine percent, or about ten percent of the photosensitive groups being cross-linked. In some embodiments, the recording material is an amorphous polymer and the writing results in between five percent and ninety percent, or about ten percent and eighty percent, or about 20 percent and 60 percent of the photosensitive groups being cross-linked. In some embodiments, the recording material is a liquid crystal polymer and the writing results in between two percent and fifty percent, or between five percent and forty percent, or between ten percent and thirty percent of the photosensitive groups being cross-linked. In some embodiments, the recording material is an amorphous polymer and the writing results in about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% of the photosensitive groups being cross-linked. In some embodiments, the recording material is a liquid crystal polymer and the writing results in about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% of the photosensitive groups being cross-linked.

In some embodiments, cross-linking photosensitive groups results in formation of a cyclobutane moiety of Formula A or Formula B:

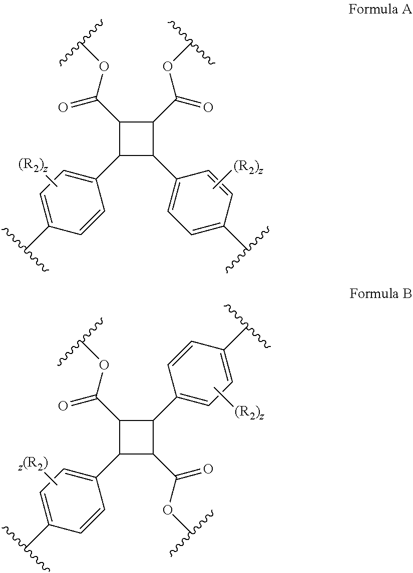

wherein in Formulas A and B: z is independently at each occurrence 0, 1, 2, 3, or 4; R₂ is independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

### BRIEF DESCRIPTION OF THE DRAWINGS

The foregoing summary, as well as the following detailed description of the invention, will be better understood when read in conjunction with the appended drawings.

FIGS. 1A-1C illustrate light patterns created by two interfering beams of different polarizations; FIG. 1A illustrates intensity patterns for same linear polarization of the beams; FIG. 1B illustrates intensity patterns for same circular polarization of the beams; FIG. 1C illustrates polarization patterns corresponding to orthogonal circular polarizations of the beams.

FIGS. 2A-2C are a schematic representation of molecular photo-orientation in a photosensitive material (shaded ellipses: photoproducts; white ellipses: non-reacted photosensitive fragments and other fragments); FIG. 2A illustrates random alignment of molecular fragments before exposure; FIG. 2B illustrates molecular orientation in the direction of light polarization E; FIG. 2C illustrates molecular orientation in the direction perpendicular to light polarization E.

### DETAILED DESCRIPTION OF THE INVENTION

Volume gratings, usually produced by holographic technique and known as volume holographic gratings (VHG) or volume holograms, are diffractive optical elements based on material with periodic phase or absorption modulation throughout the entire volume of the material. When an incident light satisfies Bragg condition it is diffracted by the grating. The diffraction occurs within a narrow range of wavelength and incidence angles. In turn, the grating has no effect on the light from the off-Bragg angular and spectral range. These gratings also demonstrate excellent multiplexing ability. Due to these properties, VHG are of great interest for various applications in optics such as data storage and diffractive optical elements for displays, fiber optic communication, spectroscopy, etc.

The conventional holographic materials for VHG are sensitive only to intensity of recording light and corresponding gratings are polarization insensitive. There is however other group of materials sensitive to both intensity and polarization of the recording light. Use of these materials opens way to anisotropic VHG characterized by polarization sensitivity that gives important degree of freedom for design and extends the field of possible applications. Depending on exposure geometry and polarization of recording beams, the resulted VHG can be sensitive to linear polarization or circular polarization. The latter known as polarization volume gratings (PVG) currently attract special research interest primarily due to potential application in beam steering devices and AR headsets.

The materials currently used as recording media for polarization sensitive VHG have different practical limitations, primarily, insufficient stability and coloring. The alternative method for recording of such gratings based on the surface mediated photoalignment of polymerizable liquid crystals has another set of limitations. When the photoalignment layer is used, liquid crystal can be arranged in only certain three-dimensional configurations. In addition, this preparation method is rather cumbersome because of deposition and processing of two organic films.

The disclosure relates to a class of holographic materials which are transparent in the entire visible range and provide enhanced stability of the recorded VHG.

Volume gratings are based on periodic phase or absorption modulation throughout the entire volume of recording material and characterized by selective diffraction at the wavelength and incidence angle of light satisfying Bragg law. Usually these gratings are produced by holographic technique and known as volume holographic gratings (VHG) or volume holograms.

Achieving of the Bragg regime of a diffraction grating is usually determined by Klein parameter Q:

$$Q = \frac{2 π λ d}{n {Λ}^{2}} ,$$

where d is a thickness of the grating, λ is a wavelength of light, Λ is a grating period, and n is an average refractive index of the recording medium. As a rule, Bragg property is achieved if Q>>1, typically, Q≥10. Thus, to meet Bragg regime, thickness of diffraction grating should be higher than some value determined by parameters of grating, recording medium and light. Because of this, VHG is also called a thick grating. On the contrary, the grating with Q<1 is usually considered as a thin one, which typically demonstrates many diffraction orders (Raman-Nath diffraction regime).

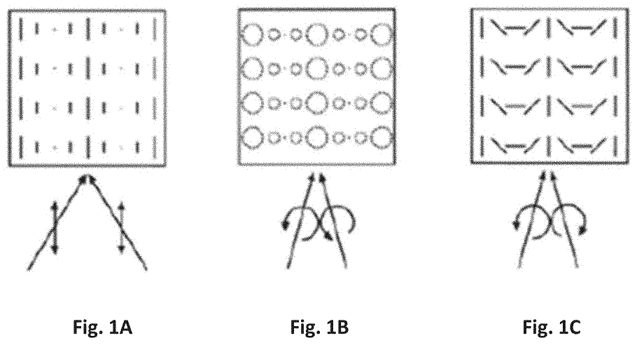

Depending on the light patterns used in recording process, the corresponding VHG are divided into two groups. The gratings induced by only periodic modulation of light intensity are usually called intensity gratings. In turn, the gratings induced by periodic modulation of light polarization and constant intensity are called polarization gratings. Some holographic geometries for generation of intensity and polarization patterns of light corresponding to one-side incidence of two recording beams are presented in FIG. 1. FIGS. 1A and 1B show intensity patterns in case of linear and circular polarization of recording beams, respectively. As shown, light polarization of the recording beams is preserved and not spatially varied. FIG. 1C shows polarization patterns generated by two coherent beams with orthogonal circular polarizations. In this case light intensity is kept constant, while light of circular polarization is transformed to the patterns of linear polarization.

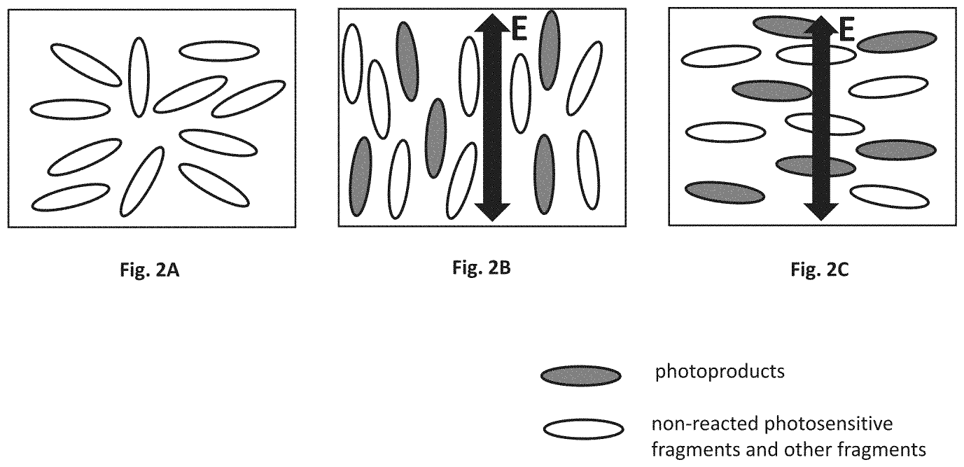

Typically, holographic materials are optically isotropic photo-polymeric compositions responsive only to intensity of recording light. In these materials, only the intensity grating can be recorded. The induced contrast of refractive index achieves 0.03. The other class of materials for optical recording demonstrates effect of photoinduced anisotropy. The anisotropic photosensitive units of these materials arrange in some preferential direction, usually perpendicular or parallel to polarization direction of recording light, see FIG. 2. Thus, in contrast to the above-mentioned photopolymers sensitive only to the intensity of recording light, these materials are sensitive to both light intensity and polarization. This allows to record both intensity and polarization gratings characterized by the induced birefringence modulated by magnitude or orientation, respectively. These anisotropic gratings may be sensitive to linear or circular polarization that gives new options in optical design. In case of Q>1, the Bragg condition is met and thus the above anisotropic gratings may be considered as the intensity or polarization volume gratings with unique optical responses.

The majority of materials demonstrating effect of photoinduced anisotropy and thus suitable for recording of anisotropic VHG sufferers from different practical limitations such as low photoinduced birefringence, insufficient stability and absorption in a visible range. This invention relates to the class of holographic polymers which are transparent in the entire visible range, provide high photoinduced birefringence and much enhanced stability of the recorded volume holograms.

The disclosure relates generally to photosensitive polymers for use in volume holography applications. Materials suitable for anisotropic volume holograms include, but are not limited to, bacteriorhodopsin, dichromated gelatin, and polymers with polarization sensitive groups. Polymers with polarization sensitive groups include, but are not limited to, homopolymers, copolymers, and polymer blends containing dichroic dyes, cinnamates, and coumarines. In some embodiments, materials include polymers and copolymers with chemically linked photosensitive fragments, for example polymers with azo dye fragments (azopolymers) undergoing trans-cis isomerization, and polymers with cinnamoyl fragments undergoing both trans-cis isomerization and (2+2)-cycloaddition reaction under irradiation. Azopolymers are capable of high photoinduced optical birefringence reaching 0.3-0.35. The cross-linking fragments occurring as a result of (2+2)-cycloaddition reaction fix the photoinduced molecular order providing high stability of the recorded orientational structures.

In some embodiments, materials for VHG include polymers containing fragments capable of (2+2)-cycloaddition, for example cinnamates, because they are colorless and not sensitive to visible light, the photoinduced anisotropy is induced only with UV light, and the photoreaction of cycloaddition fixes the induced orientational structure. In some embodiments, the induced structure, e.g. polarization grating, is photo- and thermally stable. In some embodiments, the materials include liquid crystalline polymers undergoing cycloaddition, because in these polymers the photoinduced order is enhanced by liquid crystal orientational ordering.

### Definitions

Unless defined otherwise, all technical and scientific terms used herein have the same meaning as is commonly understood by one of skill in the art to which this invention belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

Unless otherwise stated, the chemical structures depicted herein are intended to include compounds which differ only in the presence of one or more isotopically enriched atoms. For example, compounds where one or more hydrogen atoms is replaced by deuterium or tritium, or wherein one or more carbon atoms is replaced by ¹³C- or ¹⁴C-enriched carbons, are within the scope of this invention.

“Alkyl” refers to a straight or branched hydrocarbon chain radical consisting solely of carbon and hydrogen atoms, containing no unsaturation, having from one to ten carbon atoms (e.g., (C₁₋₁₀)alkyl or C₁₋₁₀ alkyl). Whenever it appears herein, a numerical range such as “1 to 10” refers to each integer in the given range—e.g., “1 to 10 carbon atoms” means that the alkyl group may consist of 1 carbon atom, 2 carbon atoms, 3 carbon atoms, etc., up to and including 10 carbon atoms, although the definition is also intended to cover the occurrence of the term “alkyl” where no numerical range is specifically designated. Typical alkyl groups include, but are in no way limited to, methyl, ethyl, propyl, isopropyl, n-butyl, isobutyl, sec-butyl isobutyl, tertiary butyl, pentyl, isopentyl, neopentyl, hexyl, septyl, octyl, nonyl and decyl. The alkyl moiety may be attached to the rest of the molecule by a single bond, such as for example, methyl (Me), ethyl (Et), n-propyl (Pr), 1-methylethyl (isopropyl), n-butyl, n-pentyl, 1,1-dimethylethyl (t-butyl) and 3-methylhexyl. Unless stated otherwise specifically in the specification, an alkyl group is optionally substituted by one or more of substituents which are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

“Alkylaryl” refers to an -(alkyl)aryl radical where aryl and alkyl are as disclosed herein and which are optionally substituted by one or more of the substituents described as suitable substituents for aryl and alkyl respectively.

“Alkylhetaryl” refers to an -(alkyl)hetaryl radical where hetaryl and alkyl are as disclosed herein and which are optionally substituted by one or more of the substituents described as suitable substituents for aryl and alkyl respectively.

“Alkylheterocycloalkyl” refers to an -(alkyl) heterocyclyl radical where alkyl and heterocycloalkyl are as disclosed herein and which are optionally substituted by one or more of the substituents described as suitable substituents for heterocycloalkyl and alkyl respectively.

An “alkene” moiety refers to a group consisting of at least two carbon atoms and at least one carbon-carbon double bond, and an “alkyne” moiety refers to a group consisting of at least two carbon atoms and at least one carbon-carbon triple bond. The alkyl moiety, whether saturated or unsaturated, may be branched, straight chain, or cyclic.

“Alkenyl” refers to a straight or branched hydrocarbon chain radical group consisting solely of carbon and hydrogen atoms, containing at least one double bond, and having from two to ten carbon atoms (i.e., (C₂₋₁₀)alkenyl or C₂₋₁₀ alkenyl). Whenever it appears herein, a numerical range such as “2 to 10” refers to each integer in the given range—e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (i.e., vinyl), prop-1-enyl (i.e., allyl), but-1-enyl, pent-1-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkenyl-cycloalkyl” refers to an -(alkenyl)cycloalkyl radical where alkenyl and cycloalkyl are as disclosed herein and which are optionally substituted by one or more of the substituents described as suitable substituents for alkenyl and cycloalkyl respectively.

“Alkynyl” refers to a straight or branched hydrocarbon chain radical group consisting solely of carbon and hydrogen atoms, containing at least one triple bond, having from two to ten carbon atoms (i.e., (C₂₋₁₀)alkynyl or C₂₋₁₀ alkynyl). Whenever it appears herein, a numerical range such as “2 to 10” refers to each integer in the given range—e.g., “2 to 10 carbon atoms” means that the alkynyl group may consist of 2 carbon atoms, 3 carbon atoms, etc., up to and including 10 carbon atoms. The alkynyl may be attached to the rest of the molecule by a single bond, for example, ethynyl, propynyl, butynyl, pentynyl and hexynyl. Unless stated otherwise specifically in the specification, an alkynyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkynyl-cycloalkyl” refers to an -(alkynyl)cycloalkyl radical where alkynyl and cycloalkyl are as disclosed herein and which are optionally substituted by one or more of the substituents described as suitable substituents for alkynyl and cycloalkyl respectively.

“Carboxaldehyde” refers to a —(C═O)H radical. “Carboxyl” refers to a —(C═O)OH radical. “Cyano” refers to a —CN radical.

“Cycloalkyl” refers to a monocyclic or polycyclic radical that contains only carbon and hydrogen, and may be saturated, or partially unsaturated. Cycloalkyl groups include groups having from 3 to 10 ring atoms (i.e. (C₃₋₁₀)cycloalkyl or C₃₋₁₀ cycloalkyl). Whenever it appears herein, a numerical range such as “3 to 10” refers to each integer in the given range—e.g., “3 to 10 carbon atoms” means that the cycloalkyl group may consist of 3 carbon atoms, etc., up to and including 10 carbon atoms. Illustrative examples of cycloalkyl groups include, but are not limited to the following moieties: cyclopropyl, cyclobutyl, cyclopentyl, cyclopentenyl, cyclohexyl, cyclohexenyl, cycloheptyl, cyclooctyl, cyclononyl, cyclodecyl, norbornyl, and the like. Unless stated otherwise specifically in the specification, a cycloalkyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Cycloalkyl-alkenyl” refers to a -(cycloalkyl)alkenyl radical where cycloalkyl and alkenyl are as disclosed herein and which are optionally substituted by one or more of the substituents described as suitable substituents for cycloalkyl and alkenyl, respectively.

“Cycloalkyl-heterocycloalkyl” refers to a -(cycloalkyl)heterocycloalkyl radical where cycloalkyl and heterocycloalkyl are as disclosed herein and which are optionally substituted by one or more of the substituents described as suitable substituents for cycloalkyl and heterocycloalkyl, respectively.

“Cycloalkyl-heteroaryl” refers to a -(cycloalkyl)heteroaryl radical where cycloalkyl and heteroaryl are as disclosed herein and which are optionally substituted by one or more of the substituents described as suitable substituents for cycloalkyl and heteroaryl, respectively.

The term “alkoxy” refers to the group —O-alkyl, including from 1 to 8 carbon atoms of a straight, branched, cyclic configuration and combinations thereof attached to the parent structure through an oxygen. Examples include, but are not limited to, methoxy, ethoxy, propoxy, isopropoxy, cyclopropyloxy and cyclohexyloxy. “Lower alkoxy” refers to alkoxy groups containing one to six carbons.

The term “substituted alkoxy” refers to alkoxy wherein the alkyl constituent is substituted (i.e., —O-(substituted alkyl)). Unless stated otherwise specifically in the specification, the alkyl moiety of an alkoxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “alkoxycarbonyl” refers to a group of the formula (alkoxy)(C═O)— attached through the carbonyl carbon wherein the alkoxy group has the indicated number of carbon atoms. Thus a (C₁₋₆)alkoxycarbonyl group is an alkoxy group having from 1 to 6 carbon atoms attached through its oxygen to a carbonyl linker. “Lower alkoxycarbonyl” refers to an alkoxycarbonyl group wherein the alkoxy group is a lower alkoxy group.

The term “substituted alkoxycarbonyl” refers to the group (substituted alkyl)-O—C(O)— wherein the group is attached to the parent structure through the carbonyl functionality. Unless stated otherwise specifically in the specification, the alkyl moiety of an alkoxycarbonyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Acyl” refers to the groups (alkyl)-C(O)—, (aryl)-C(O)—, (heteroaryl)-C(O)—, (heteroalkyl)-C(O)— and (heterocycloalkyl)-C(O)—, wherein the group is attached to the parent structure through the carbonyl functionality. If the R radical is heteroaryl or heterocycloalkyl, the hetero ring or chain atoms contribute to the total number of chain or ring atoms. Unless stated otherwise specifically in the specification, the alkyl, aryl or heteroaryl moiety of the acyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Acyloxy” refers to a R(C═O)O— radical wherein R is alkyl, aryl, heteroaryl, heteroalkyl or heterocycloalkyl, which are as described herein. If the R radical is heteroaryl or heterocycloalkyl, the hetero ring or chain atoms contribute to the total number of chain or ring atoms. Unless stated otherwise specifically in the specification, the R of an acyloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Amino” or “amine” refers to a —N(R^{a})₂ radical group, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two R^{a} substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{d}, and NR^{d}R^{d} each as described above. N-oxides can be prepared by treatment of the corresponding amino group with, for example, hydrogen peroxide or m-chloroperoxybenzoic acid.

“Amide” or “amido” refers to a chemical moiety with formula —C(O)N(R)₂ or —NHC(O)R, where R is selected from the group consisting of hydrogen, alkyl, cycloalkyl, aryl, heteroaryl (bonded through a ring carbon) and heteroalicyclic (bonded through a ring carbon), each of which moiety may itself be optionally substituted. The R₂ of —N(R)₂ of the amide may optionally be taken together with the nitrogen to which it is attached to form a 4-, 5-, 6- or 7-membered ring. Unless stated otherwise specifically in the specification, an amido group is optionally substituted independently by one or more of the substituents as described herein for alkyl, cycloalkyl, aryl, heteroaryl, or heterocycloalkyl. An amide may be an amino acid or a peptide molecule attached to a compound disclosed herein, thereby forming a prodrug. The procedures and specific groups to make such amides are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety.

“Aromatic” or “aryl” or “Ar” refers to an aromatic radical with six to ten ring atoms (e.g., C₆-C₁₀ aromatic or C₆-C₁₀ aryl) which has at least one ring having a conjugated pi electron system which is carbocyclic (e.g., phenyl, fluorenyl, and naphthyl). Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” refers to each integer in the given range; e.g., “6 to 10 ring atoms” means that the aryl group may consist of 6 ring atoms, 7 ring atoms, etc., up to and including 10 ring atoms. The term includes monocyclic or fused-ring polycyclic (i.e., rings which share adjacent pairs of ring atoms) groups. Unless stated otherwise specifically in the specification, an aryl moiety is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl. It is understood that a substituent R attached to an aromatic ring at an unspecified position,

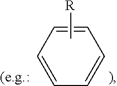

includes one or more, and up to the maximum number of possible substituents.

The term “aryloxy” refers to the group —O-aryl.

The term “substituted aryloxy” refers to aryloxy wherein the aryl substituent is substituted (i.e., —O-(substituted aryl)). Unless stated otherwise specifically in the specification, the aryl moiety of an aryloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Aralkyl” or “arylalkyl” refers to an (aryl)alkyl-radical where aryl and alkyl are as disclosed herein and which are optionally substituted by one or more of the substituents described as suitable substituents for aryl and alkyl respectively.

“Ester” refers to a chemical radical of formula —COOR, where R is selected from the group consisting of alkyl, cycloalkyl, aryl, heteroaryl (bonded through a ring carbon) and heteroalicyclic (bonded through a ring carbon). The procedures and specific groups to make esters are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety. Unless stated otherwise specifically in the specification, an ester group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Fluoroalkyl” refers to an alkyl radical, as defined above, that is substituted by one or more fluoro radicals, as defined above, for example, trifluoromethyl, difluoromethyl, 2,2,2-trifluoroethyl, 1-fluoromethyl-2-fluoroethyl, and the like. The alkyl part of the fluoroalkyl radical may be optionally substituted as defined above for an alkyl group.

“Halo,” “halide,” or, alternatively, “halogen” is intended to mean fluoro, chloro, bromo or iodo. The terms “haloalkyl,” “haloalkenyl,” “haloalkynyl,” and “haloalkoxy” include alkyl, alkenyl, alkynyl and alkoxy structures that are substituted with one or more halo groups or with combinations thereof. For example, the terms “fluoroalkyl” and “fluoroalkoxy” include haloalkyl and haloalkoxy groups, respectively, in which the halo is fluorine.

“Heteroalkyl,” “heteroalkenyl,” and “heteroalkynyl” refer to optionally substituted alkyl, alkenyl and alkynyl radicals and which have one or more skeletal chain atoms selected from an atom other than carbon, e.g., oxygen, nitrogen, sulfur, phosphorus or combinations thereof. A numerical range may be given—e.g., C₁-C₄ heteroalkyl which refers to the chain length in total, which in this example is 4 atoms long. A heteroalkyl group may be substituted with one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heteroalkylaryl” refers to an -(heteroalkyl)aryl radical where heteroalkyl and aryl are as disclosed herein and which are optionally substituted by one or more of the substituents described as suitable substituents for heteroalkyl and aryl, respectively.

“Heteroalkylheteroaryl” refers to an -(heteroalkyl)heteroaryl radical where heteroalkyl and heteroaryl are as disclosed herein and which are optionally substituted by one or more of the substituents described as suitable substituents for heteroalkyl and heteroaryl, respectively.

“Heteroalkylheterocycloalkyl” refers to an -(heteroalkyl)heterocycloalkyl radical where heteroalkyl and heterocycloalkyl are as disclosed herein and which are optionally substituted by one or more of the substituents described as suitable substituents for heteroalkyl and heterocycloalkyl, respectively.

“Heteroalkylcycloalkyl” refers to an -(heteroalkyl)cycloalkyl radical where heteroalkyl and cycloalkyl are as disclosed herein and which are optionally substituted by one or more of the substituents described as suitable substituents for heteroalkyl and cycloalkyl, respectively.

“Heteroaryl” or “heteroaromatic” or “HetAr” refers to a 5- to 18-membered aromatic radical (e.g., C₅-C₁₃ heteroaryl) that includes one or more ring heteroatoms selected from nitrogen, oxygen and sulfur, and which may be a monocyclic, bicyclic, tricyclic or tetracyclic ring system. Whenever it appears herein, a numerical range such as “5 to 18” refers to each integer in the given range—e.g., “5 to 18 ring atoms” means that the heteroaryl group may consist of 5 ring atoms, 6 ring atoms, etc., up to and including 18 ring atoms. Bivalent radicals derived from univalent heteroaryl radicals whose names end in “-yl” by removal of one hydrogen atom from the atom with the free valence are named by adding “-idene” to the name of the corresponding univalent radical—e.g., a pyridyl group with two points of attachment is a pyridylidene. A N-containing “heteroaromatic” or “heteroaryl” moiety refers to an aromatic group in which at least one of the skeletal atoms of the ring is a nitrogen atom. The polycyclic heteroaryl group may be fused or non-fused. The heteroatom(s) in the heteroaryl radical are optionally oxidized. One or more nitrogen atoms, if present, are optionally quaternized. The heteroaryl may be attached to the rest of the molecule through any atom of the ring(s). Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl(benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (i.e., thienyl). Unless stated otherwise specifically in the specification, a heteroaryl moiety is optionally substituted by one or more substituents which are independently: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

Substituted heteroaryl also includes ring systems substituted with one or more oxide (—O—) substituents, such as, for example, pyridinyl N-oxides.

“Heteroarylalkyl” refers to a moiety having an aryl moiety, as described herein, connected to an alkylene moiety, as described herein, wherein the connection to the remainder of the molecule is through the alkylene group.

“Heterocycloalkyl” refers to a stable 3- to 18-membered non-aromatic ring radical that comprises two to twelve carbon atoms and from one to six heteroatoms selected from nitrogen, oxygen and sulfur. Whenever it appears herein, a numerical range such as “3 to 18” refers to each integer in the given range—e.g., “3 to 18 ring atoms” means that the heterocycloalkyl group may consist of 3 ring atoms, 4 ring atoms, etc., up to and including 18 ring atoms. Unless stated otherwise specifically in the specification, the heterocycloalkyl radical is a monocyclic, bicyclic, tricyclic or tetracyclic ring system, which may include fused or bridged ring systems. The heteroatoms in the heterocycloalkyl radical may be optionally oxidized. One or more nitrogen atoms, if present, are optionally quaternized. The heterocycloalkyl radical is partially or fully saturated. The heterocycloalkyl may be attached to the rest of the molecule through any atom of the ring(s). Examples of such heterocycloalkyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocycloalkyl moiety is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heterocycloalkyl” also includes bicyclic ring systems wherein one non-aromatic ring, usually with 3 to 7 ring atoms, contains at least 2 carbon atoms in addition to 1-3 heteroatoms independently selected from oxygen, sulfur, and nitrogen, as well as combinations including at least one of the foregoing heteroatoms; and the other ring, usually with 3 to 7 ring atoms, optionally contains 1-3 heteroatoms independently selected from oxygen, sulfur, and nitrogen and is not aromatic.

“Nitro” refers to the —NO₂ radical.

“Oxa” refers to the —O— radical. “Oxo” refers to the ═O radical.

“Isomers” are different compounds that have the same molecular formula. “Stereoisomers” are isomers that differ only in the way the atoms are arranged in space—i.e., having a different stereochemical configuration. “Enantiomers” are a pair of stereoisomers that are non-superimposable mirror images of each other. A 1:1 mixture of a pair of enantiomers is a “racemic” mixture. The term “(±)” is used to designate a racemic mixture where appropriate. “Diastereoisomers” are stereoisomers that have at least two asymmetric atoms, but which are not mirror-images of each other. The absolute stereochemistry is specified according to the Cahn-Ingold-Prelog R—S system. When a compound is a pure enantiomer the stereochemistry at each chiral carbon can be specified by either (R) or (S). Resolved compounds whose absolute configuration is unknown can be designated (+) or (−) depending on the direction (dextro- or levorotatory) which they rotate plane polarized light at the wavelength of the sodium D line. Certain of the compounds described herein contain one or more asymmetric centers and can thus give rise to enantiomers, diastereomers, and other stereoisomeric forms that can be defined, in terms of absolute stereochemistry, as (R) or (S). The present chemical entities, compositions and methods are meant to include all such possible isomers, including racemic mixtures, optically pure forms and intermediate mixtures. Optically active (R)- and (S)-isomers can be prepared using chiral synthons or chiral reagents, or resolved using conventional techniques. When the compounds described herein contain olefinic double bonds or other centers of geometric asymmetry, and unless specified otherwise, it is intended that the compounds include both E and Z geometric isomers.

“Enantiomeric purity” as used herein refers to the relative amounts, expressed as a percentage, of the presence of a specific enantiomer relative to the other enantiomer. For example, if a compound, which may potentially have an (R)- or an (S)-isomeric configuration, is present as a racemic mixture, the enantiomeric purity is about 50% with respect to either the (R)- or (S)-isomer. If that compound has one isomeric form predominant over the other, for example, 80% (S)-isomer and 20% (R)-isomer, the enantiomeric purity of the compound with respect to the (S)-isomeric form is 80%. The enantiomeric purity of a compound can be determined in a number of ways known in the art, including but not limited to chromatography using a chiral support, polarimetric measurement of the rotation of polarized light, nuclear magnetic resonance spectroscopy using chiral shift reagents which include but are not limited to lanthanide containing chiral complexes or Pirkle's reagents, or derivatization of a compounds using a chiral compound such as Mosher's acid followed by chromatography or nuclear magnetic resonance spectroscopy.

In some embodiments, enantiomerically enriched compositions have different properties than the racemic mixture of that composition. Enantiomers can be isolated from mixtures by methods known to those skilled in the art, including chiral high pressure liquid chromatography (HPLC) and the formation and crystallization of chiral salts; or preferred enantiomers can be prepared by asymmetric syntheses. See, for example, Jacques, et al., Enantiomers, Racemates and Resolutions, Wiley Interscience, New York (1981); E. L. Eliel, Stereochemistry of Carbon Compounds, McGraw-Hill, New York (1962); and E. L. Eliel and S. H. Wilen, Stereochemistry of Organic Compounds, Wiley-Interscience, New York (1994).

The terms “enantiomerically enriched” and “non-racemic,” as used herein, refer to compositions in which the percent by weight of one enantiomer is greater than the amount of that one enantiomer in a control mixture of the racemic composition (e.g., greater than 1:1 by weight). For example, an enantiomerically enriched preparation of the (S)-enantiomer, means a preparation of the compound having greater than 50% by weight of the (S)-enantiomer relative to the (R)-enantiomer, such as at least 75% by weight, or such as at least 80% by weight. In some embodiments, the enrichment can be significantly greater than 80% by weight, providing a “substantially enantiomerically enriched” or a “substantially non-racemic” preparation, which refers to preparations of compositions which have at least 85% by weight of one enantiomer relative to other enantiomer, such as at least 90% by weight, or such as at least 95% by weight. The terms “enantiomerically pure” or “substantially enantiomerically pure” refers to a composition that comprises at least 98% of a single enantiomer and less than 2% of the opposite enantiomer.

“Moiety” refers to a specific segment or functional group of a molecule. Chemical moieties are often recognized chemical entities embedded in or appended to a molecule.

“Tautomers” are structurally distinct isomers that interconvert by tautomerization. “Tautomerization” is a form of isomerization and includes prototropic or proton-shift tautomerization, which is considered a subset of acid-base chemistry. “Prototropic tautomerization” or “proton-shift tautomerization” involves the migration of a proton accompanied by changes in bond order, often the interchange of a single bond with an adjacent double bond. Where tautomerization is possible (e.g., in solution), a chemical equilibrium of tautomers can be reached. An example of tautomerization is keto-enol tautomerization. A specific example of keto-enol tautomerization is the interconversion of pentane-2,4-dione and 4-hydroxypent-3-en-2-one tautomers. Another example of tautomerization is phenol-keto tautomerization. A specific example of phenol-keto tautomerization is the interconversion of pyridin-4-ol and pyridin-4(1H)-one tautomers.

A “leaving group or atom” is any group or atom that will, under selected reaction conditions, cleave from the starting material, thus promoting reaction at a specified site. Examples of such groups, unless otherwise specified, include halogen atoms and mesyloxy, p-nitrobenzensulphonyloxy and tosyloxy groups.

“Protecting group” is intended to mean a group that selectively blocks one or more reactive sites in a multifunctional compound such that a chemical reaction can be carried out selectively on another unprotected reactive site and the group can then be readily removed or deprotected after the selective reaction is complete. A variety of protecting groups are disclosed, for example, in T. H. Greene and P. G. M. Wuts, Protective Groups in Organic Synthesis, Third Edition, John Wiley & Sons, New York (1999).

“Solvate” refers to a compound in physical association with one or more molecules of a pharmaceutically acceptable solvent.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono- and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

“Sulfanyl” refers to groups that include —S-(optionally substituted alkyl), —S-(optionally substituted aryl), —S-(optionally substituted heteroaryl) and —S-(optionally substituted heterocycloalkyl).

“Sulfinyl” refers to groups that include —S(O)—H, —S(O)-(optionally substituted alkyl), —S(O)-(optionally substituted amino), —S(O)-(optionally substituted aryl), —S(O)-(optionally substituted heteroaryl) and —S(O)-(optionally substituted heterocycloalkyl).

“Sulfonyl” refers to groups that include —S(O₂)—H, —S(O₂)-(optionally substituted alkyl), —S(O₂)-(optionally substituted amino), —S(O₂)-(optionally substituted aryl), —S(O₂)-(optionally substituted heteroaryl), and —S(O₂)-(optionally substituted heterocycloalkyl).

“Sulfonamidyl” or “sulfonamido” refers to a —S(═O)₂—NRR radical, where each R is selected independently from the group consisting of hydrogen, alkyl, cycloalkyl, aryl, heteroaryl (bonded through a ring carbon) and heteroalicyclic (bonded through a ring carbon). The R groups in —NRR of the —S(═O)₂—NRR radical may be taken together with the nitrogen to which it is attached to form a 4-, 5-, 6- or 7-membered ring. A sulfonamido group is optionally substituted by one or more of the substituents described for alkyl, cycloalkyl, aryl, heteroaryl, respectively.

“Sulfoxyl” refers to a —S(═O)₂OH radical.

“Sulfonate” refers to a —S(═O)₂—OR radical, where R is selected from the group consisting of alkyl, cycloalkyl, aryl, heteroaryl (bonded through a ring carbon) and heteroalicyclic (bonded through a ring carbon). A sulfonate group is optionally substituted on R by one or more of the substituents described for alkyl, cycloalkyl, aryl, heteroaryl, respectively.

Compounds of the invention also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, diseases, formulae, compounds or groups) described in conjunction with a particular aspect, embodiment or example of the invention are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any disclosed embodiments. The invention extends to any novel one, or novel combination, of the features disclosed in this specification (including any accompanying claims, abstract and drawings), or to any novel one, or any novel combination, of the steps of any method or process so disclosed.

### Volume Holograms and Photosensitive Polymers

One embodiment of the invention relates to a recording material for a volume hologram, wherein the recording material is characterized by a thickness and includes a compound including a moiety of Formula 1:

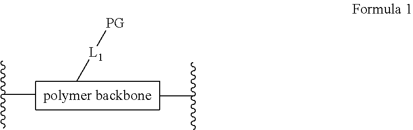

wherein the moiety of Formula 1 includes a polymer backbone, and a side chain including a linker L₁ and a photosensitive group PG. In some embodiments, the side chain is mesogenic. In some embodiments, the moiety of Formula 1 further includes a terminal group T₁ as in Formula 2:

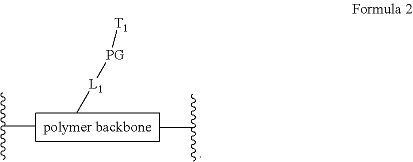

In some embodiments, the photosensitive group includes a cycloaddition precursor (CAP). In some embodiments, the photosensitive group includes a cinnamate moiety. Any CAP known in the art can be used. In some embodiments, the CAP is selected from a cinnamate moiety and a chromenone moiety. Other CAP include maleimide and anthracenyl moieties. In some embodiments, the linker L₂ includes one or more of a single bond, a double bond, a triple bond, a carbonyl group, a carboxyl group, a methylene group, an ether group, and an optionally substituted phenylene group. In some embodiments, the terminal group T₁ includes one or more of a single bond, a double bond, a triple bond, an optionally substituted phenylene group, a carbonyl group, a carboxyl group, a methylene group, an ether group, —H, —OH, —CH₃, —N(CH₃)₂, —C₂H₅, —C₃H₇, —CN, —NO₂, —OCH₃, —OC₂H₅, and —OC₃H₇. In some embodiments, the phenylene group is a 1,4-phenylene group. In some embodiments, the polymer backbone includes a homopolymer fragment or a copolymer fragment. In some embodiments, the polymer backbone includes one or more of a polysiloxane fragment, a polymethylmethacrylate (PMMA) fragment, a polyacrylate fragment, a polymethacrylate fragment, a cellulose fragment, a polyvinyl fragment, a polyurethane fragment, a polyamic acid fragment, or a polyimide fragment. In some embodiments, the polymer backbone includes a cellulose cinnamate fragment derived from a pyranose polymer or a furanose polymer. Other suitable polymeric backbones are described for example in U.S. Pat. Nos. 6,572,939 and 9,360,708. The polymeric backbone can have other side chains, for example phenyl groups, halo groups, benzyloxy groups, acyl groups, and the like.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 101 to 105:

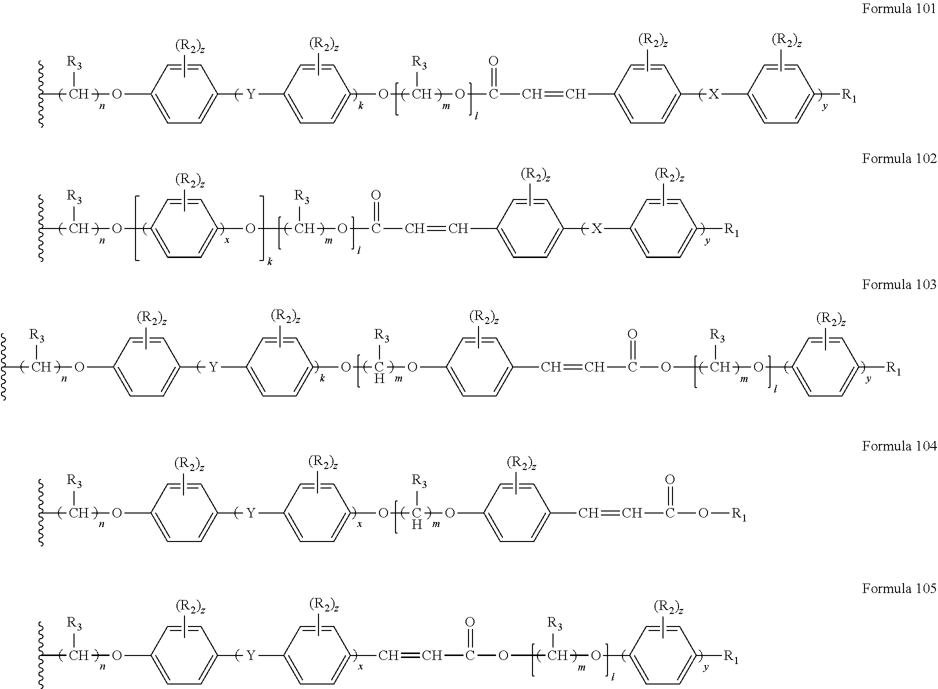

wherein in Formulas 101 to 105: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; X and Y are independently selected from a single bond, a double bond, a triple bond, —C(O)—, —C(O)O—, —OC(O)—, and —C(O)NR^{a}; R₁ is independently selected from —H, —OH, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 106 to 117:

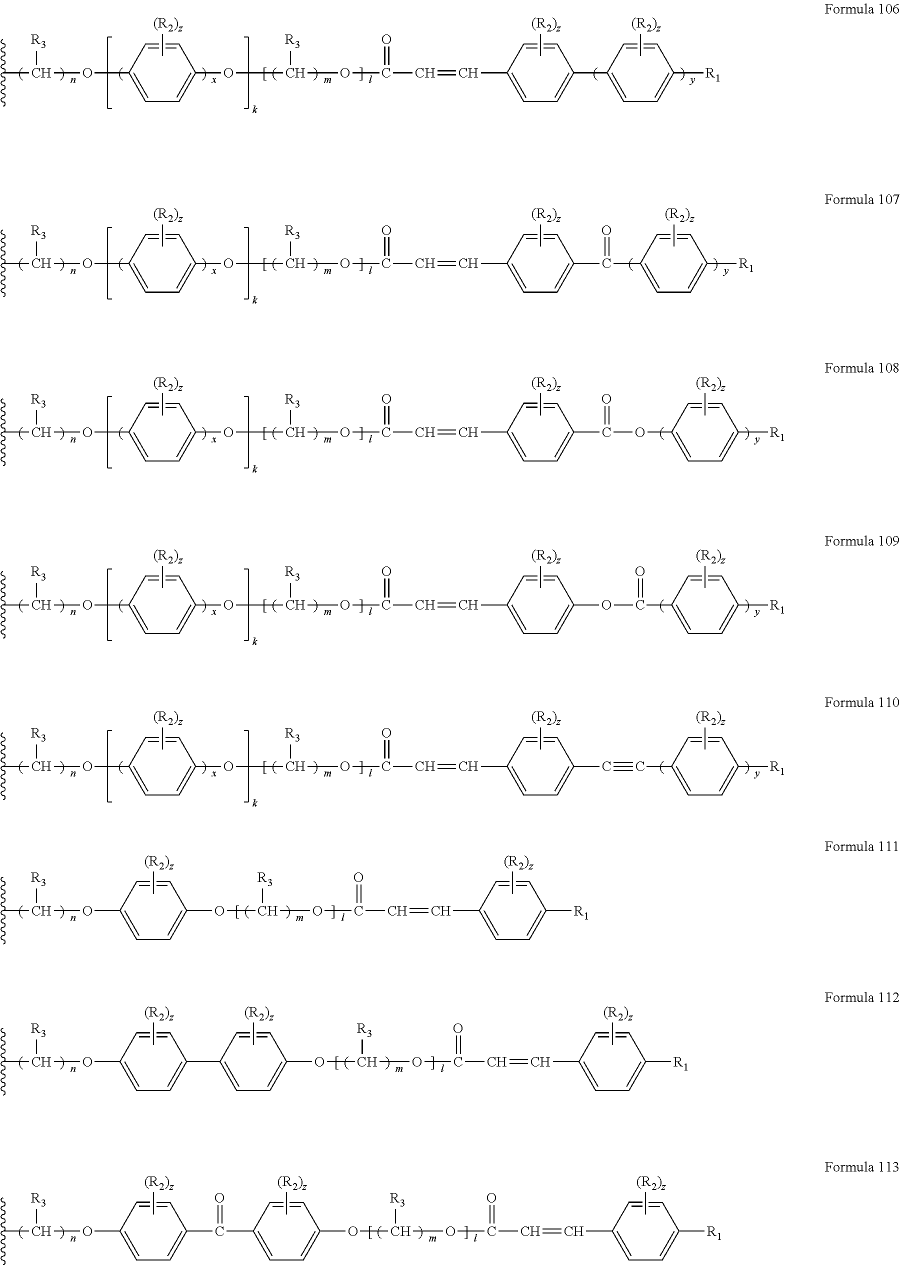

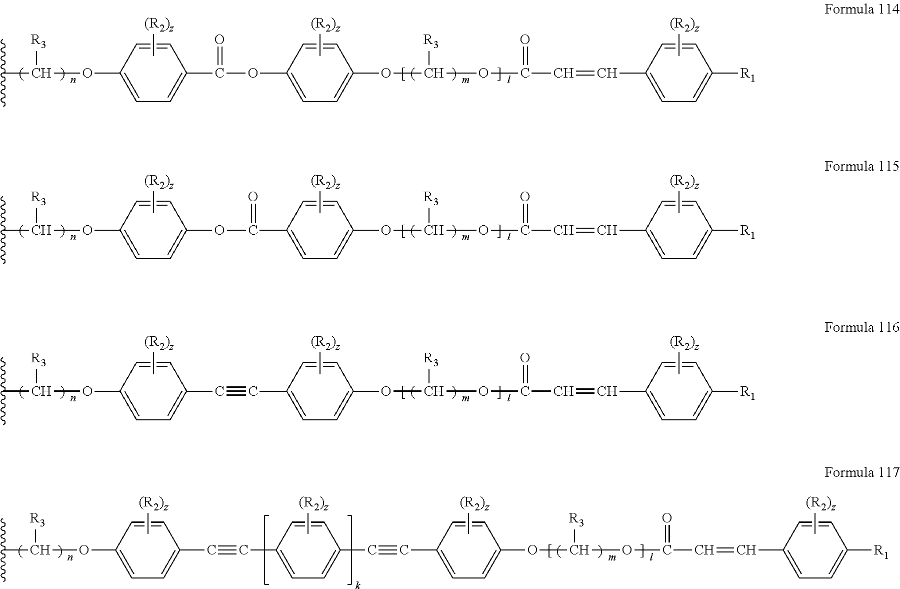

wherein in Formulas 106 to 117: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; R₁ is independently selected from —H, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 118 to 123:

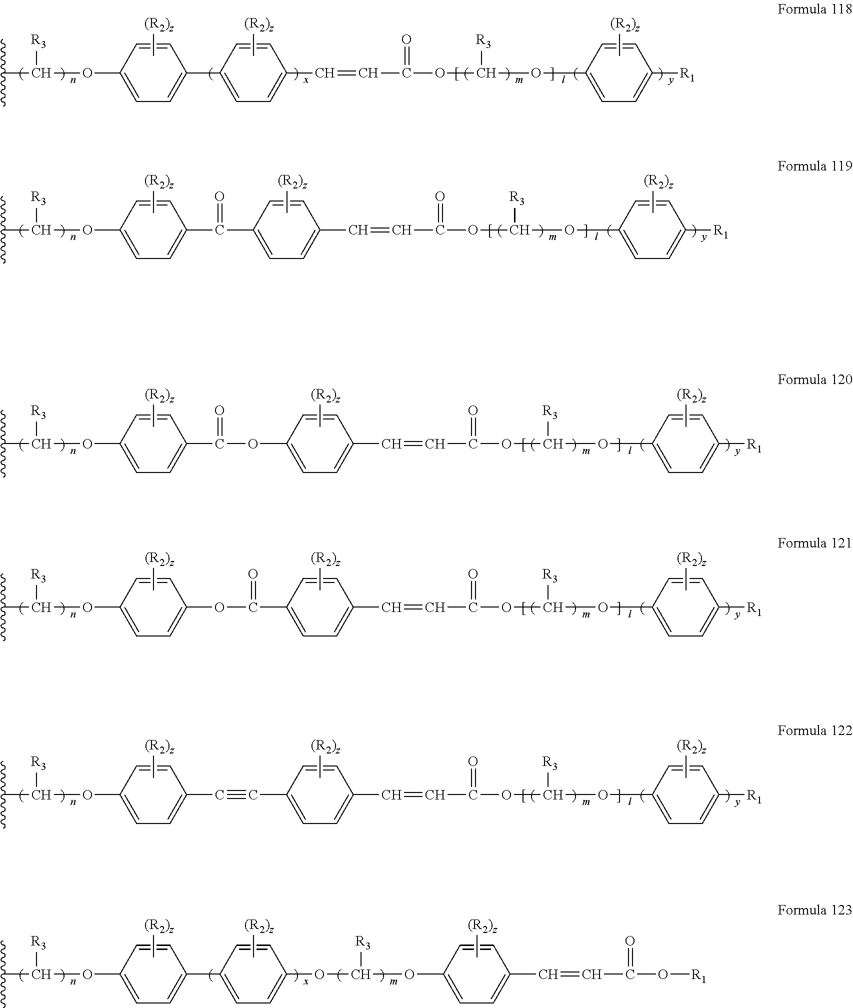

wherein in Formulas 118 to 123: n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4; R₁ is independently selected from —H, —OH, —CH₃, —NR^{a}R^{b}, —C₂H₅, —C₃H₇, —CN, —NO₂, —OCH₃, —OC₂H₅, and —OC₃H₇; R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 124 to 131:

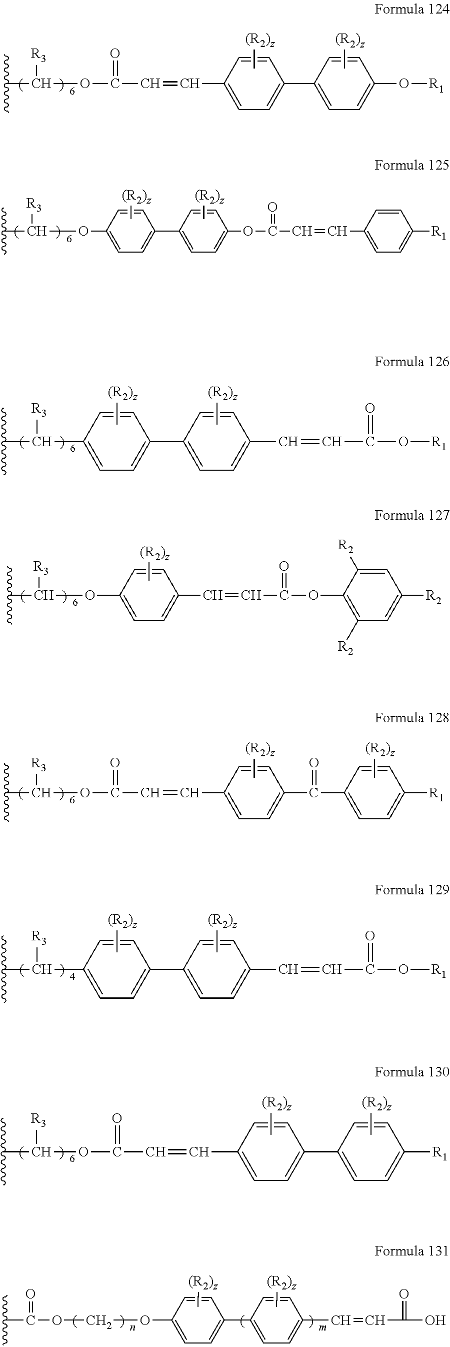

wherein in Formulas 124 to 131: z is independently at each occurrence 0, 1, 2, 3, or 4; n is independently an integer from 0 to 12; m is independently 0 or 1; R₁, R₂, and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

Another embodiment of the invention relates to a recording material for a volume hologram, wherein the recording material is characterized by a thickness and includes a compound including a moiety of Formula 1, wherein the moiety of Formula 1 includes a polymer backbone, and a side chain, wherein the side chain is of any one of Formulas 1001 to 1011:

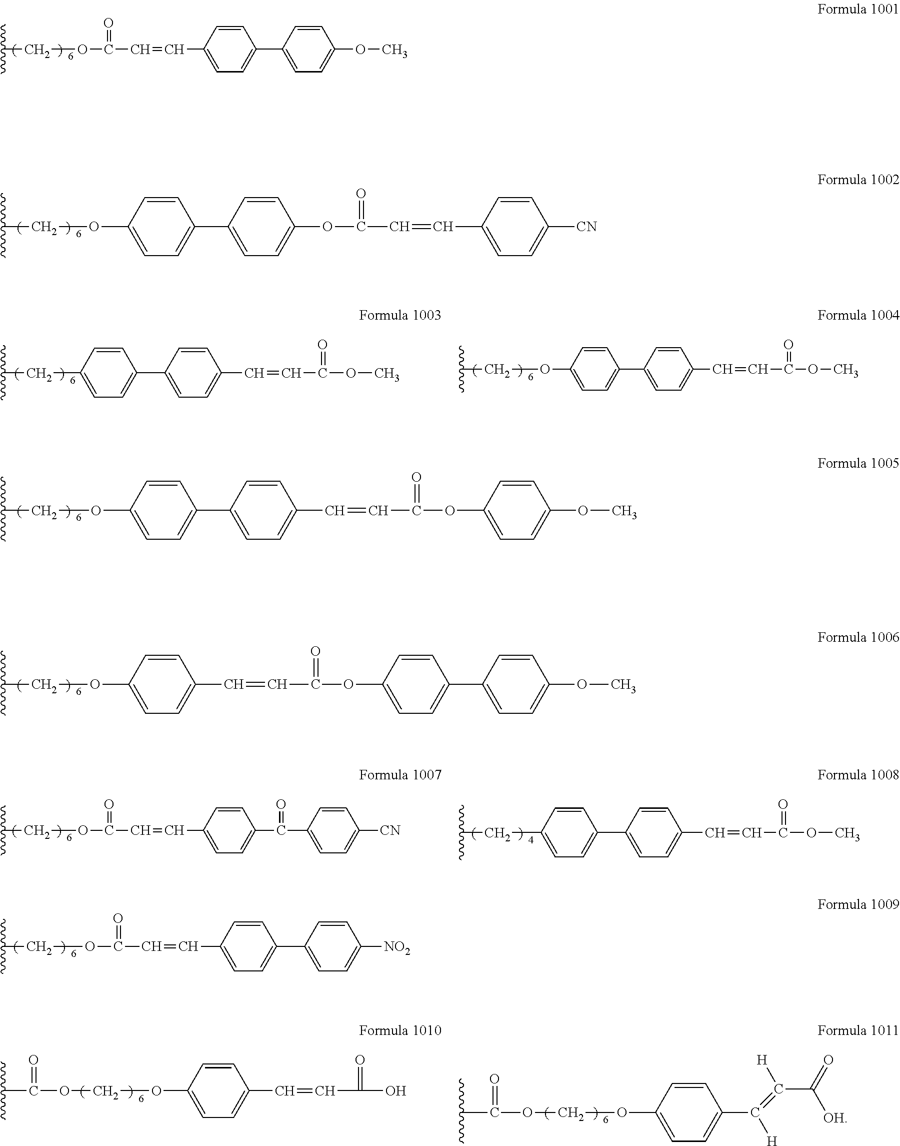

Another embodiment of the invention relates to a recording material for a volume hologram, wherein the recording material is characterized by a thickness and includes a compound including a moiety of Formula 1, wherein the moiety of Formula 1 is of any one of Formulas 2001 to 2014:

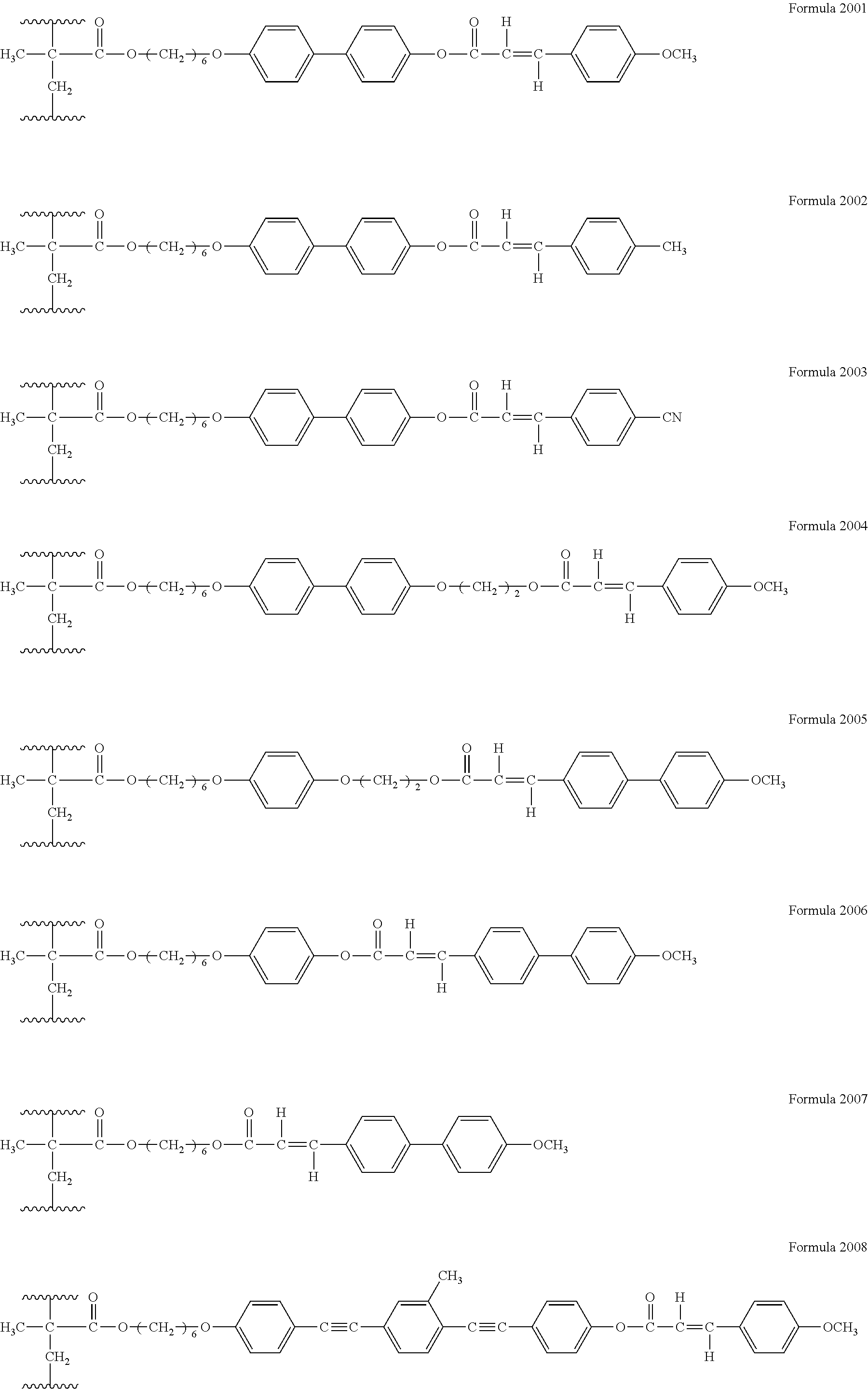

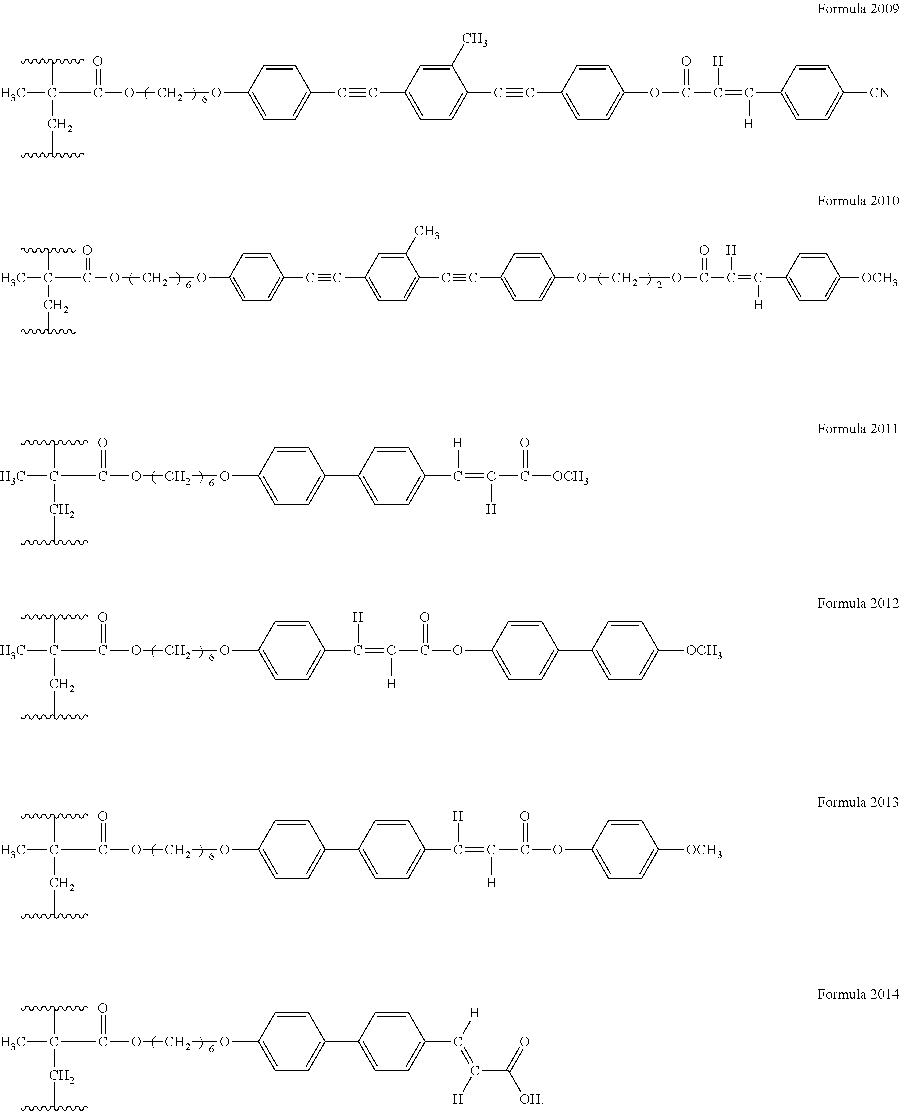

Another embodiment of the invention relates to a recording material for a volume hologram, wherein the recording material is characterized by a thickness and includes a compound including a moiety of Formula 1, wherein a volume hologram recorded in the recording material is characterized by a Q parameter that is equal to or greater than 10, or equal to or greater than 5, wherein

$$Q = \frac{2 π {λ}_{0} d}{{n }_{0} {Λ}^{2}}$$

and wherein: λ₀ is a recording wavelength, d is the thickness of the volume hologram, n₀ is a refractive index of the volume hologram, and Λ is a grating constant (fringe spacing) of the volume hologram. Other gratings have been described in the art, for example by Stracke et al., 2000, “Gain Effects in Optical Storage: Thermal Induction of a Surface Relief Grating in a Smectic Liquid Crystal,” Adv. Material 12(4) pp. 282-285. In some embodiments, the thickness of the recording material (and the volume hologram recorded in the recording material) is between 0.5 m and 1000 m. Another embodiment of the invention relates to a recording material for a volume hologram, wherein the recording material is characterized by a thickness and includes a compound including a moiety of Formula 1, wherein: the volume hologram is characterized by the induced birefringence of greater than 0.002, greater than 0.04, or greater than 0.10. In some embodiments, the compound is optically transparent to visible light.

Another embodiment of the invention relates to a recording material for a volume hologram, wherein the recording material has a liquid crystal phase and is characterized by a thickness and includes a compound including a moiety of Formula 1, wherein the compound is arranged in liquid crystal phase on the substrate. In some embodiments, the compound aligns parallel in relation to the substrate. In some embodiments, the alignment of photosensitive compound is induced by light. In some embodiments, the alignment of photosensitive compound induced by light is enhanced by keeping the exposed material in liquid crystal phase. In some embodiments, the birefringence of the material including the photosensitive compound is induced by light. In some embodiments, the birefringence of the material including the photosensitive compound induced by light is magnified by keeping the exposed material in liquid crystal phase. Without wishing to be bound by any particular theory, it is believed that a film of material can be exposed at room temperature when the material is in crystalline or glassy phase, and then heated to come to range of liquid crystal (LC) phase, where photoinduced alignment is enhanced by intrinsic self-organization in LC phase. In some embodiments, the compound aligns parallel. In some embodiments, the compound aligns homeotropically. In some embodiments, the compound is arranged in tilted alignment. In some embodiments, the compound is arranged in twisted alignment. In some embodiments, the compound aligns parallel in relation to the substrate. In some embodiments, the compound aligns homeotropically in relation to the substrate. In some embodiments, the compound is arranged in tilted alignment in relation to the substrate. In some embodiments, the compound is arranged in twisted alignment in relation to the substrate.

Another embodiment of the invention relates to a recording material for a volume hologram, wherein the recording material is characterized by a thickness and includes a compound including a moiety of Formula 1, and wherein a volume hologram recorded in the recording material is a polarization grating.

Another embodiment of the invention relates to a recording material for a volume hologram, wherein the recording material is characterized by a thickness and includes a compound including a moiety of Formula 1, and wherein a volume hologram recorded in the recording material is an intensity grating.

As described herein, a holographic recording medium or substrate is formed such that holographic writing and reading to the medium are possible. Typically, fabrication of the medium involves depositing a combination, blend, mixture, etc., of the support matrix/polymerizable component/photoinitiator component, between two plates using, for example, a gasket to contain the mixture. The plates are typically glass, but it is also possible to use other materials transparent to the radiation used to write data, e.g., a plastic such as polycarbonate or poly(methyl methacrylate). It is possible to use spacers between the plates to maintain a desired thickness for the recording medium. In applications requiring optical flatness, the liquid mixture may shrink during cooling (if a thermoplastic) or curing (if a thermoset) and thus distort the optical flatness of the article. To reduce such effects, it is useful to place the article between plates in an apparatus containing mounts, e.g., vacuum chucks, capable of being adjusted in response to changes in parallelism and/or spacing. In such an apparatus, it is possible to monitor the parallelism in real-time by use of conventional interferometric methods, and to make any necessary adjustments to the heating/cooling process. In some embodiments, an article or substrate of the present disclosure may have an antireflective coating and/or be edge sealed to exclude water and/or oxygen. An antireflective coating may be deposited on an article or substrate by various processes such as chemical vapor deposition and an article or substrate may be edge sealed using known methods. In some embodiments, the photorecording material is also capable of being supported in other ways. More conventional polymer processing can also be used, e.g., closed mold formation or sheet extrusion. A stratified medium can also be used, e.g., a medium containing multiple substrates, e.g., glass, with layers of photorecording material disposed between the substrates.

In some embodiments, a holographic film or substrate described herein is a film composite consisting of one or more substrate films, one or more photopolymer films and one or more protective films in any desired arrangement. In some embodiments, materials or material composites of the substrate layer are based on polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulphone, cellulose triacetate (CTA), polyamide, polymethyl methacrylate, polyvinyl chloride, polyvinyl butyral or polydicyclopentadiene or mixtures thereof. In addition, material composites, such as film laminates or coextrudates, can be used as substrate film. Examples of material composites are duplex and triplex films having a structure according to one of the schemes A/B, A/B/A or A/B/C, such as PC/PET, PET/PC/PET and PC/TPU (TPU=thermoplastic polyurethane). In some embodiments, PC and PET are used as substrate film. Transparent substrate films which are optically clear, e.g. not hazy, can be used in some embodiments. The haze is measurable via the haze value, which is less than 3.5%, or less than 1%, or less than 0.3%. The haze value describes the fraction of transmitted light which is scattered in a forward direction by the sample through which radiation has passed. Thus, it is a measure of the opacity or haze of transparent materials and quantifies material defects, particles, inhomogeneities or crystalline phase boundaries in the material or its surface that interfere with the transparency. The method for measuring the haze is described in the standard ASTM D 1003.

In some embodiments, the substrate film has an optical retardation that is not too high, e.g. a mean optical retardation of less than 1000 nm, or of less than 700 nm, or of less than 300 nm. The automatic and objective measurement of the optical retardation is effected using an imaging polarimeter. The optical retardation is measured in perpendicular incidence. The retardation values stated for the substrate film are lateral mean values.

In some embodiments, the substrate film, including possible coatings on one or both sides, has a thickness of 5 to 2000 μm, or of 8 to 300 μm, or of 30 to 200, or of 125 to 175 μm, or of 30 to 45 μm.

In some embodiments, the film composite can have one or more covering layers on the photopolymer layer in order to protect it from dirt and environmental influences. Plastics films or film composite systems, but also clearcoats can be used for this purpose. In some embodiments, covering layers are film materials analogous to the materials used in the substrate film, having a thickness of 5 to 200 μm, or of 8 to 125 μm, or of 20 to 50 μm. In some embodiments, covering layers having as smooth a surface as possible are preferred. The roughness can be determined according to DIN EN ISO 4288. In some embodiments, roughness is in the region of less than or equal to 2 μm, or less than or equal to 0.5 μm. In some embodiments, PE or PET films having a thickness of 20 to 60 μm cam be used as laminating films. In some embodiments, a polyethylene film of 40 μm thickness can be used. In some embodiments, further protective layers, for example a backing of the substrate film, may be used.

### Data Structure Writing

Another embodiment of the invention relates to a process for writing a data structure including information into a recording material, wherein the recording material is characterized by a thickness and includes a compound including a moiety of Formula 1, the process including: orienting a coherent light source toward the volume hologram; and cross-linking through a cycloaddition reaction a portion of the total number of photosensitive groups in the recording material using the light source thereby forming the volume hologram; wherein the information of the data structure is stored in the form of selective cross-linking of the photosensitive groups in a pattern corresponding to the information. In some embodiments, the writing results in between two percent and thirty percent of the photosensitive groups being cross-linked. In some embodiments, the writing results in between three percent and twenty percent of the photosensitive groups being cross-linked. In some embodiments, the recording material is an amorphous polymer and the writing results in between five percent and ninety percent of the photosensitive groups being cross-linked. In some embodiments, the recording material is a liquid crystal polymer and the writing results in between two percent and fifty percent of the photosensitive groups being cross-linked.

In some embodiments, the coherent light source includes: a first incident light beam, and a second incident light beam originating from the coherent light source, and wherein the first incident light beam and the second incident light beam both enter the recording material and interfere in the recording material. Polarization holography relating to gratings including azo-dyes has been described in the art, for example by Blanche et al., 2000, “Polarization holography reveals the nature of the grating in polymers containing azo-dye,” Optics communications 185, iss. 1-3, pp. 1-12; FIG. 3 on pages 4-5. In some embodiments, the incident light beams are linearly polarized and their polarization directions are parallel. In some embodiments, the incident light beams are linearly polarized and their polarization directions are perpendicular. In some embodiments, the first incident light beam is circularly polarized in a first direction, and the second incident light beam is circularly polarized in the first direction. In some embodiments, the first incident light beam is circularly polarized in a first direction, and the second incident light beam is circularly polarized in a direction opposite the first direction. In one embodiment of the present invention the first incident light beam and the second incident light beam impinge upon the same surface of a recording layer. In another embodiment of the present invention the first incident light beam and the second incident light beam impinge upon opposite surfaces of a recording layer.

In some embodiments, the writing results in between four percent and twenty percent of the photosensitive groups being cross-linked. In some embodiments, the writing results in about five percent, or about six percent, or about seven percent, or about eight percent, or about nine percent, or about ten percent of the photosensitive groups being cross-linked. In some embodiments, the writing results in about eleven percent, or about twelve percent, or about thirteen percent, or about eight fourteen percent, or about fifteen percent, or about sixteen percent of the photosensitive groups being cross-linked. In some embodiments, the recording material is an amorphous polymer and the writing results in between five percent and ninety percent, or about ten percent and eighty percent, or about 20 percent and 60 percent of the photosensitive groups being cross-linked. In some embodiments, the recording material is a liquid crystal polymer and the writing results in between two percent and fifty percent, or between five percent and forty percent, or between ten percent and thirty percent of the photosensitive groups being cross-linked. In some embodiments, the recording material is an amorphous polymer and the writing results in about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% of the photosensitive groups being cross-linked. In some embodiments, the recording material is a liquid crystal polymer and the writing results in about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% of the photosensitive groups being cross-linked. In some embodiments, cross-linking photosensitive groups results in formation of a cyclobutane moiety of Formula A or Formula B:

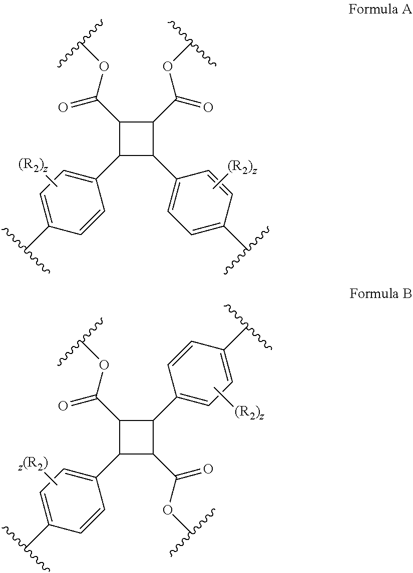

wherein in Formulas A and B: z is independently at each occurrence 0, 1, 2, 3, or 4; R₂ is independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

### Photosensitive Monomers and Polymerization Thereof

In one embodiment, the invention relates to a photosensitive compound of Formula C or D:

M-L₁-PG Formula C

M-L₁-PG-T₁ Formula D

wherein M is a monomer capable of undergoing a polymerization or polycondensation reaction, L₁-PG or L₁-PG-T₁ are side chains, and PG is a photosensitive group comprising a cycloaddition precursor (CAP) moiety. Any side chain described herein can be attached to any monomer known in the art. In some embodiments, the monomer is an unsaturated hydrocarbon moiety, for example ethylene, propylene, or the like. In some embodiments, M is an acrylate moiety. In some embodiments, M is a sugar. In some embodiments, the PG is selected from a cinnamate moiety and a chromenone moiety. Other CAP include maleimide and anthracenyl moieties.

In some embodiments, the invention relates to a photosensitive polymer of Formula E or F:

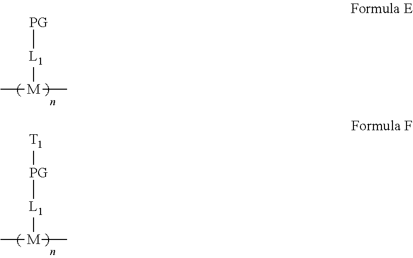

In some embodiments, the polymer is obtained through a polymerization or polycondensation reaction of a monomer of Formula C or D. Any side chain L₁-PG or L₁-PG-T₁ described herein can be attached to any monomer known in the art. In some embodiments, the monomer is an unsaturated hydrocarbon moiety, for example ethylene, propylene, or the like. In some embodiments, M is an acrylate moiety. In some embodiments, M is a sugar. In some embodiments, the CAP is selected from a cinnamate moiety and a chromenone moiety. Other CAP include maleimide and anthracenyl moieties. In some embodiments, the polymer is obtained by attaching one or more side chains to a pre-synthesized polymer backbone. In some embodiments, the polymer is a homopolymer. In some embodiments, the polymer is a homopolymer with photoreactive side chains. In some embodiments, the polymer is a co-polymer. In some embodiments, the polymer is a co-polymer with photoreactive side chains.

In some embodiments, other side chains can be added, having different, and/or additional functionality compared to the photoreactive side chains: mesogenic chains supporting liquid crystallinity, side chains used as photosensitizers, side chains with chiral groups to induce twisted orientational structures, and the like. In some embodiments, the polymer may include blends of homopolymers and/or co-polymers, as well as monomers, blends of polymers and low molecular weight compounds with cinnamate or other photoreactive groups as well as other additives like photosensitizers, photoinitiators, chiral dopants, etc.

While preferred embodiments of the invention are shown and described herein, such embodiments are provided by way of example only and are not intended to otherwise limit the scope of the invention. Various alternatives to the described embodiments of the invention may be employed in practicing the invention.

A number of patent and non-patent publications are cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

### APPENDIX TO THE SPECIFICATION

Some embodiments are described with reference to the following clauses.

1. A recording material for forming a volume hologram, wherein the recording material is characterized by a thickness and comprises a compound comprising a moiety of Formula 1:

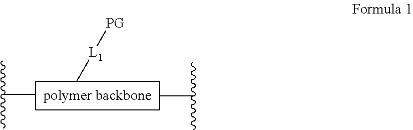

wherein the moiety of Formula I comprises a polymer backbone, and a side chain comprising a linker L₁ and a photosensitive group PG.

2. The recording material of clause 1, wherein the moiety of Formula I further comprises a terminal group T₁ as in Formula 2:

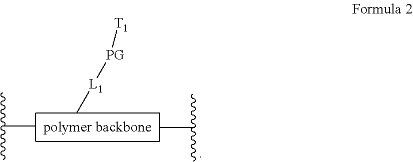

3. The recording material of clause 1 or clause 2, wherein the photosensitive group comprises a cycloaddition precursor (CAP).

4. The recording material of clause 3, wherein the cycloaddition precursor comprises a cinnamate moiety.

5. The recording material of any one of clauses 1 to 4, wherein the linker L₂ comprises one or more of a single bond, a double bond, a triple bond, a carbonyl group, a carboxyl group, a methylene group, an ether group, and an optionally substituted phenylene group.

6. The recording material of any one of clauses 1 to 5, wherein the terminal group T₁ comprises one or more of a single bond, a double bond, a triple bond, an optionally substituted phenylene group, a carbonyl group, a carboxyl group, a methylene group, an ether group, —H, —OH, —CH₃, —N(CH₃)₂, —C₂H₅, —C₃H₇, —CN, —NO₂, —OCH₃, —OC₂H₅, and —OC₃H₇.

7. The recording material of clause 5 or 6, wherein the phenylene group is a 1,4-phenylene group.

8. The recording material of any one of clauses 1 to 7, wherein the polymer backbone comprises a homopolymer fragment or a copolymer fragment.

9. The recording material of any one of clauses 1 to 8, wherein the polymer backbone comprises one or more of a polysiloxane fragment, a polymethylmethacrylate (PMMA) fragment, a polyacrylate fragment, a polymethacrylate fragment, a cellulose fragment, a polyvinyl fragment, a polyurethane fragment, a polyamic acid fragment, or a polyimide fragment.

10. The recording material of any one of clauses 1 to 9, wherein the side chain is of any one of Formulas 101 to 105:

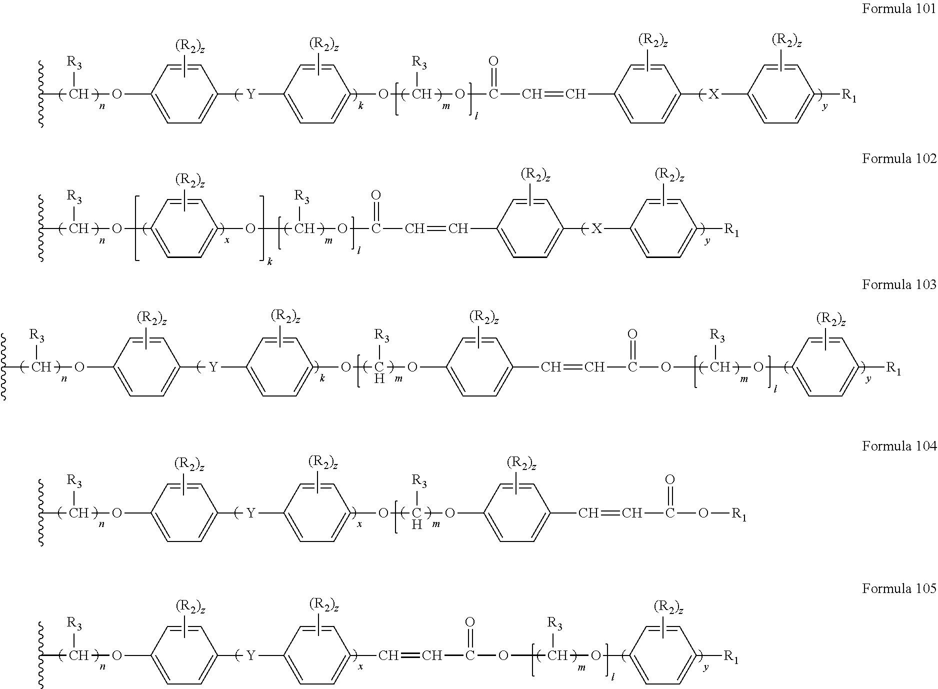

wherein in Formulas 101 to 105:

n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;

X and Y are independently selected from a single bond, a double bond, a triple bond, —C(O)—, —C(O)O—, —OC(O)—, and —C(O)NR^{a};

R₁ is independently selected from —H, —OH, —CH₃, —NR^{a}R^{b}, —C₂H₅, —C₃H₇, —CN, —NO₂, —OCH₃, —OC₂H₅, and —OC₃H₇;

R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and

R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

11. The recording material of any one of clauses 1 to 9, wherein the side chain is of any one of Formulas 106 to 117:

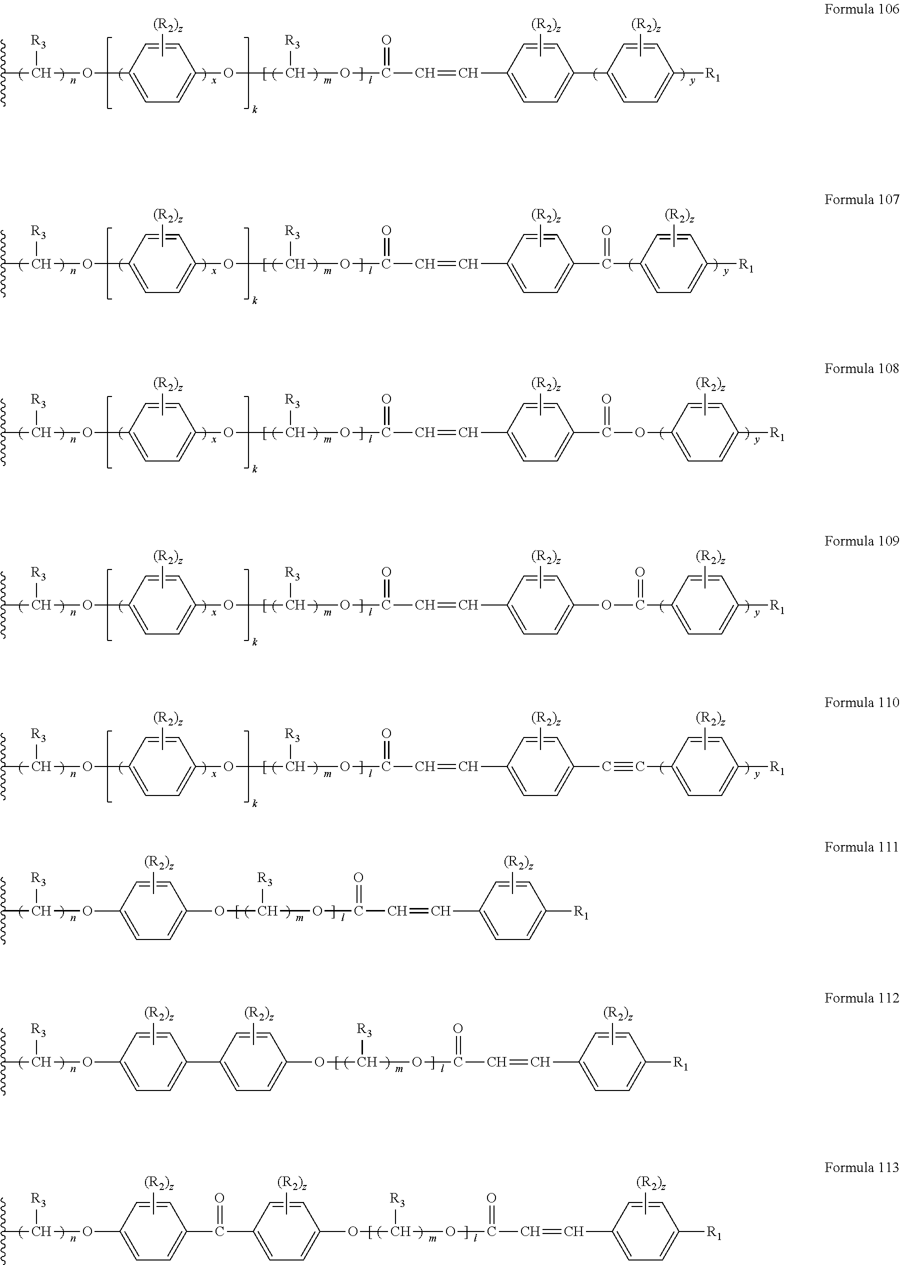

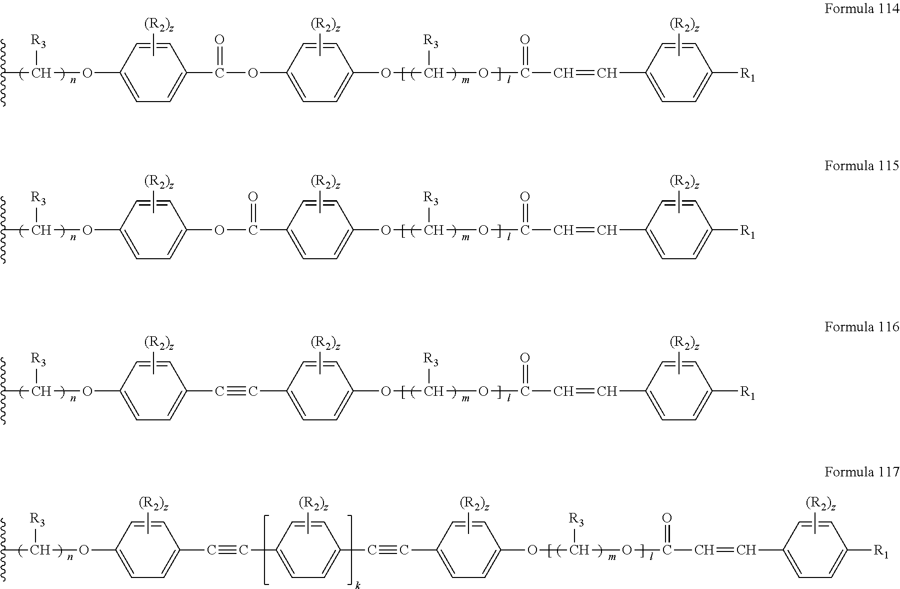

wherein in Formulas 106 to 117:

n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;

R₁ is independently selected from —H, —OH, —CH₃, —NR^{a}R^{b}, —C₂H₅, —C₃H₇, —CN, —NO₂, —OCH₃, —OC₂H₅, and —OC₃H₇;

R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and

R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

12. The recording material of any one of clauses 1 to 9, wherein the side chain is of any one of Formulas 118 to 123:

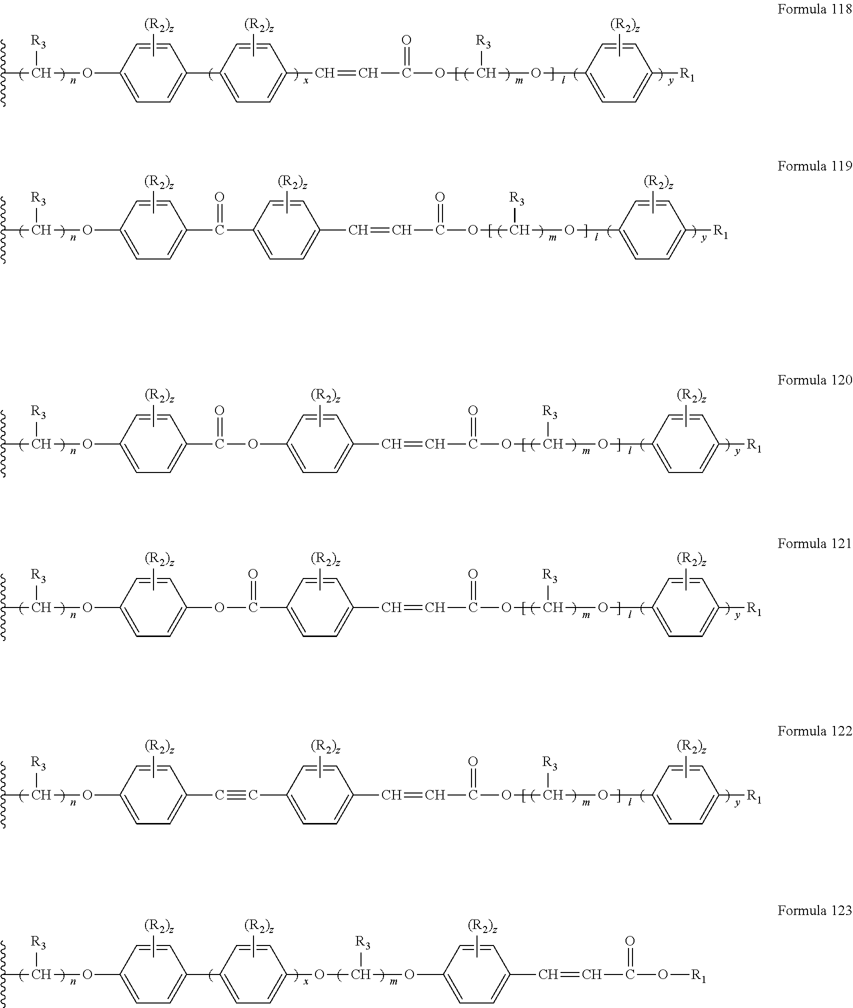

wherein in Formulas 118 to 123:

n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;

R₁ is independently selected from —H, —OH, —CH₃, —NR^{a}R^{b}, —C₂H₅, —C₃H₇, —CN, —NO₂, —OCH₃, —OC₂H₅, and —OC₃H₇;

R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and

R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

13. The recording material of any one of clauses 1 to 9, wherein the side chain is of any one of Formulas 124 to 131:

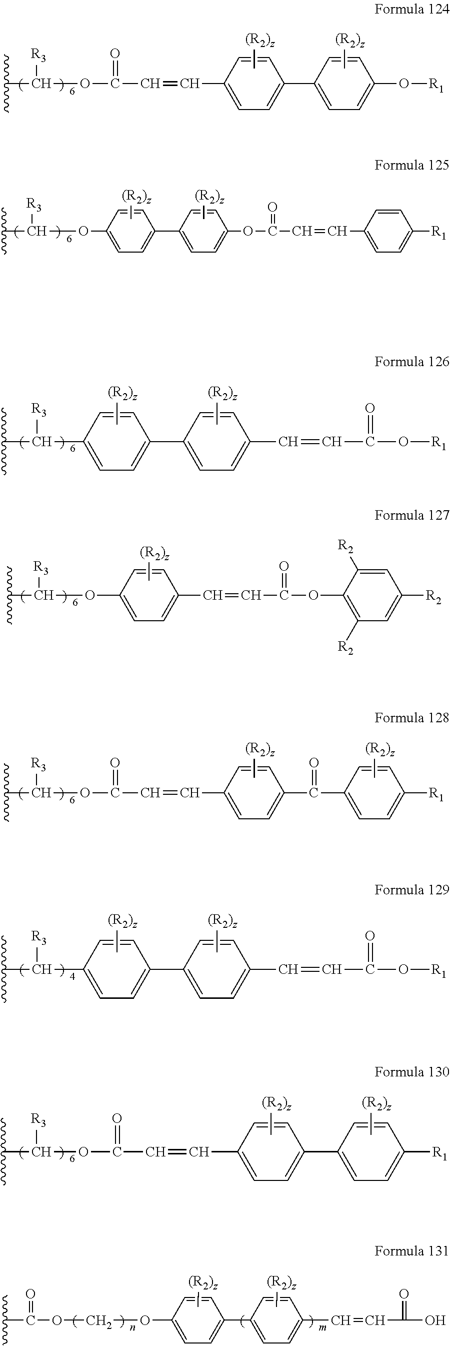

wherein in Formulas 124 to 131:

z is independently at each occurrence 0, 1, 2, 3, or 4, n is independently an integer from 0 to 12, and m is independently 0 or 1;

R₁, R₂, and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and

R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

14. The recording material of any one of clauses 1 to 9, wherein the side chain is of any one of Formulas 1001 to 1011:

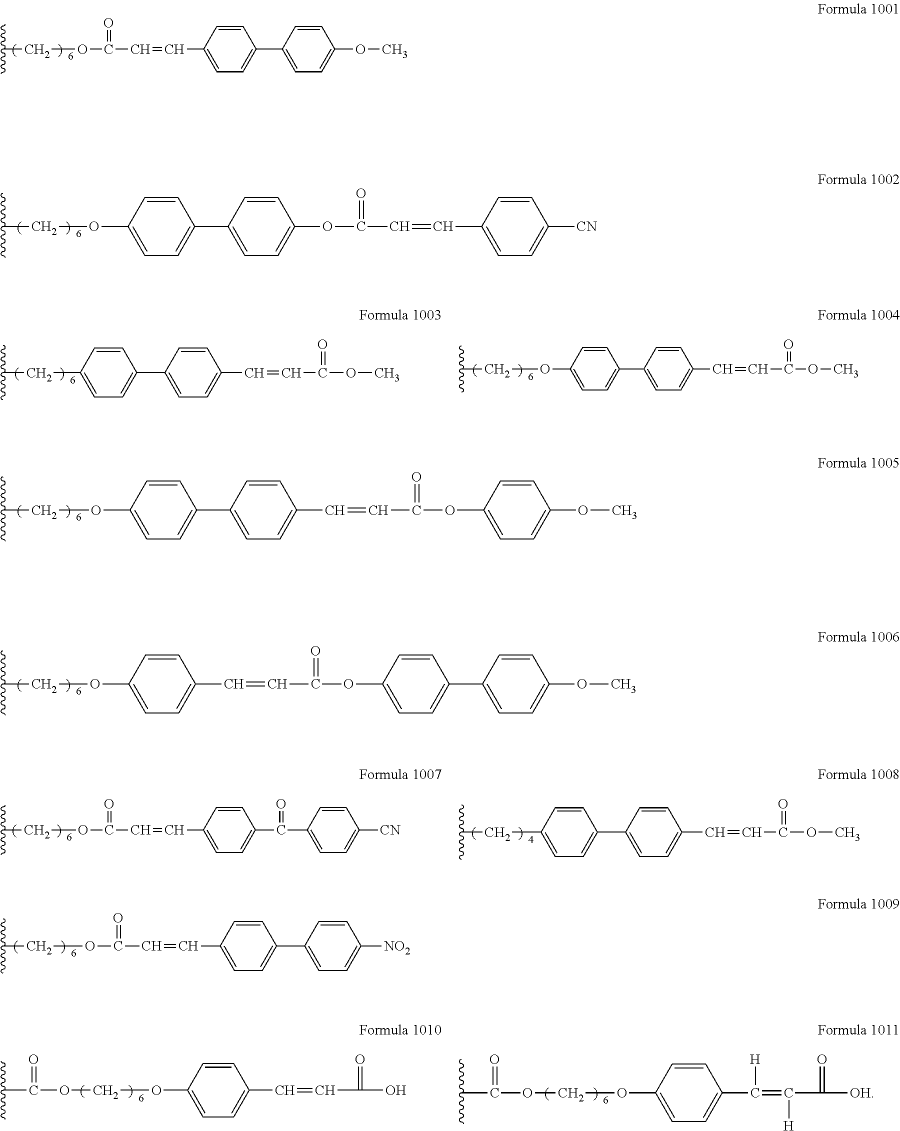

15. The recording material of any one of clauses 1 to 9, wherein the moiety of Formula 1 is of any one of Formulas 2001 to 2014:

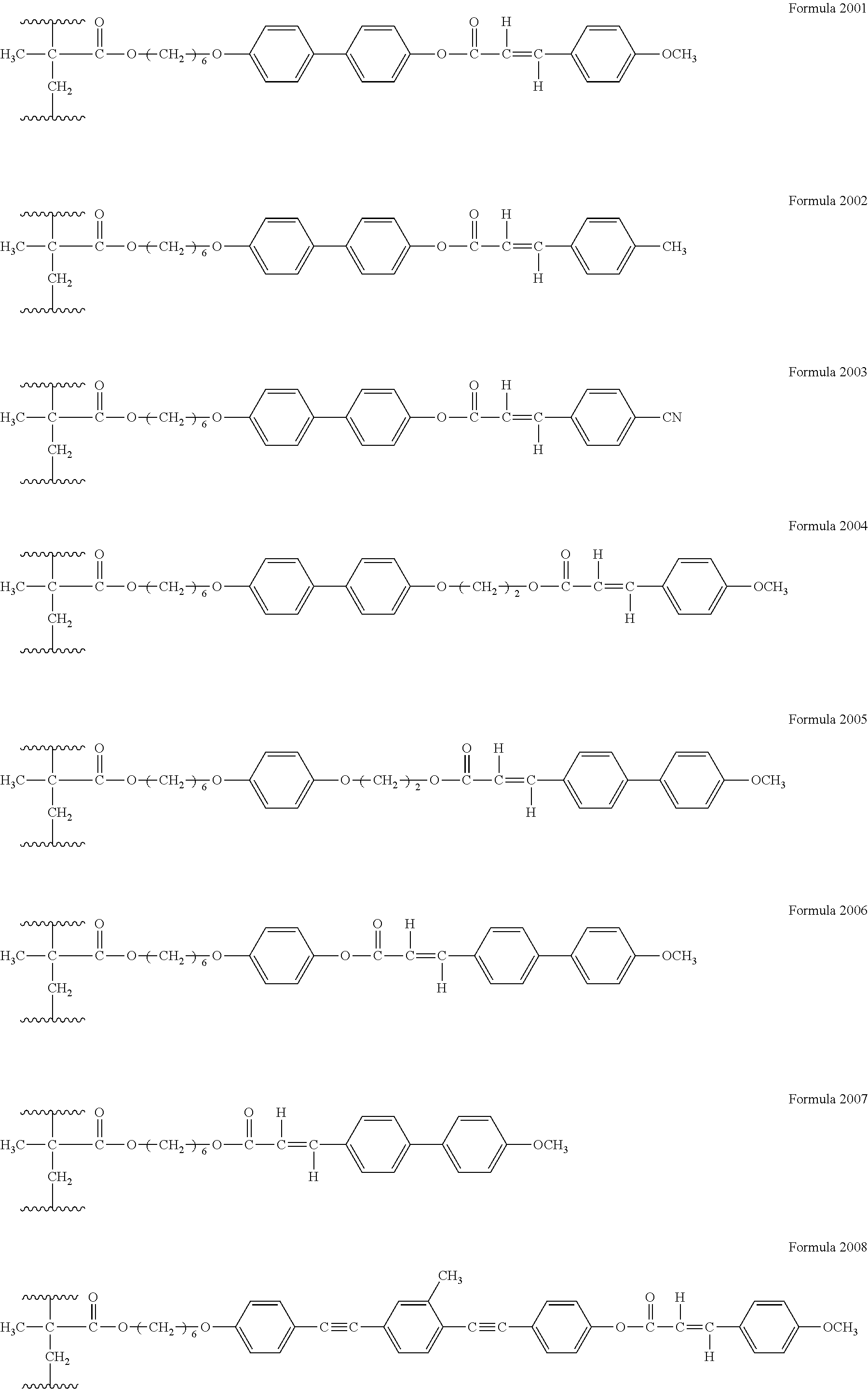

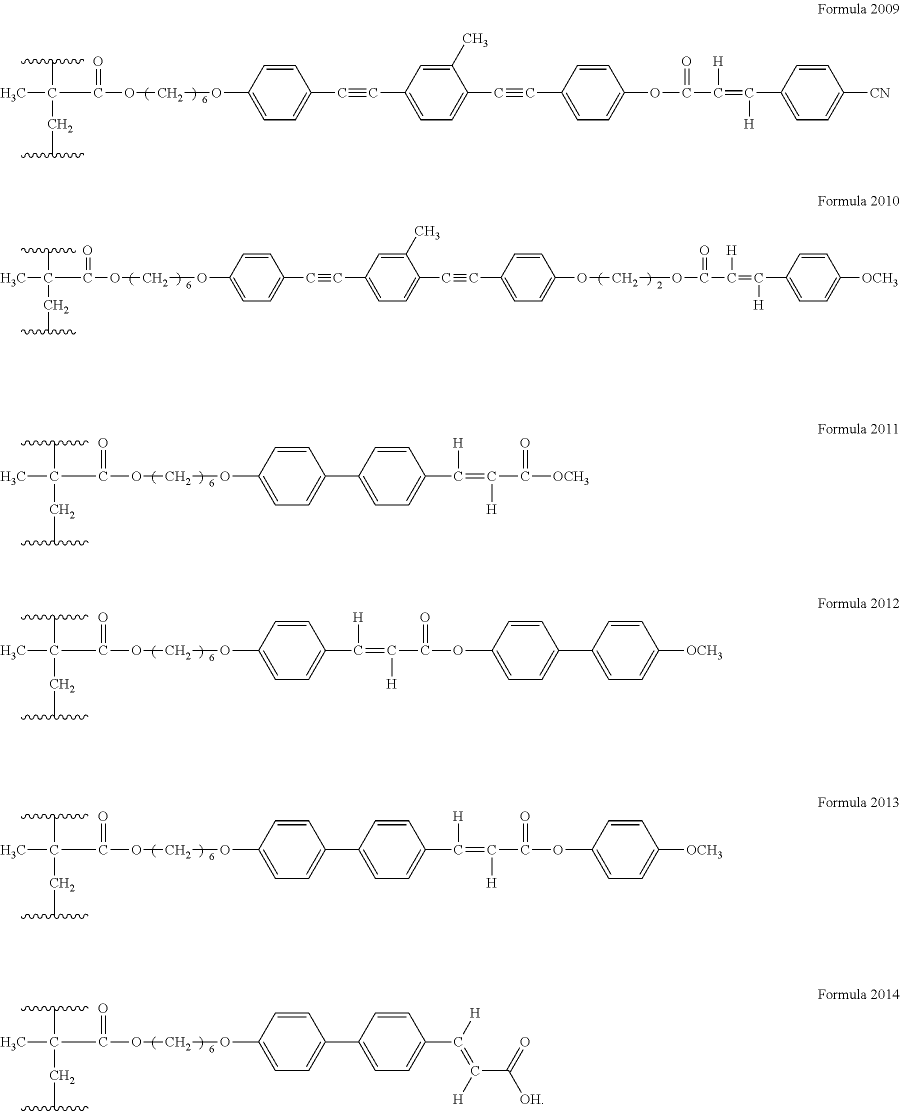

16. The recording material of any one of clauses 1 to 15, wherein the volume grating is recorded in the recording material that is characterized by a Q parameter that is equal to or greater than 1, wherein

$$Q = \frac{2 π λ d}{n {Λ}^{2}}$$

wherein,

λ is a wavelength of diffracting light,

d is the thickness of the recording material,

n is an average refractive index of the recording material for wavelength λ, and

Λ is a grating period (fringe spacing).

17. The recording material of clause 16, wherein Q is equal to or greater than 5.

18. The recording material of clause 16, wherein Q is equal to or greater than 10.

19. The recording material of any one of clauses 1 to 18 wherein the thickness of the recording material is between 0.5 Lm and 500 m.

20. The recording material of any one of clauses 1 to 19 wherein the compound is a liquid crystal polymer.

21. The recording material of any one of clauses 1 to 19 wherein the compound is an amorphous polymer.

22. The recording material of any one of clauses 1 to 21, wherein the compound is optically transparent to visible light.

23. The recording material of any one of clauses 1 to 22, wherein the compound is optically aligned.

24. The recording material of clause 23, wherein the material is characterized by optically induced birefringence.

25. The recording material of clause 24, wherein the optically induced birefringence changes with the energy of optical exposure.

26. The recording material of clause 25, wherein the optically induced birefringence is varied in the range from 0 to about 0.05.

27. The recording material of clause 25, wherein the optically induced birefringence is varied in the range from 0 to about 0.01.

28. The recording material of clause 25, wherein the optically induced birefringence is varied in the range from 0 to about 0.002.

29. The recording material of any one of clauses 1-20 and 22-28, wherein the optically induced alignment is modified by keeping the exposed recording material in liquid crystal phase.

30. The recording material of clause 29, wherein the compound is aligned in liquid crystal phase in the direction induced by optical alignment.

31. The recording material of clause 29, wherein the compound is aligned in liquid crystal phase in the direction different from the direction induced by optical alignment.

32. The recording material of clause 29, wherein the compound is aligned in liquid crystal phase parallel relative to the layer of the material.

33. The recording material of clause 29, wherein the compound aligns perpendicularly in relation to the layer of the material.

34. The recording material of clause 29, wherein the compound is arranged in tilted alignment in relation to the layer of the material.

35. The recording material of clause 29, wherein the compound is arranged in twisted configuration.

36. The recording material of clause 29, wherein the optically induced birefringence is magnified by keeping the exposed recording material in liquid crystal phase.

37. The recording material of clause 36 wherein the maximal value of birefringence in visible spectral range is greater than 0.1.

38. The recording material of clause 36 wherein the maximal value of birefringence in visible spectral range is greater than 0.2.

39. The recording material of clause 36 wherein the maximal value of birefringence in visible spectral range is greater than 0.3.

40. The recording material of clause 16, wherein the volume hologram is a polarization hologram.

41. The recording material of clause 16, wherein the volume hologram is an intensity hologram.

42. A process for holographic writing a data structure comprising information into the recording material of any one of clauses 1 to 41, the process comprising:

creating a periodic light field by providing two or more coherent light beams which overlap and interfere;

setting the recording material in the overlapping area of the beams; and

cross-linking through a cycloaddition reaction a portion of the total number of photosensitive groups in the recording material using the coherent light beams thereby forming a volume hologram;

wherein the information of the data structure is stored in the form of selective cross-linking of the photosensitive groups in a pattern corresponding to the information.

43. The process of clause 42, wherein the recording setup comprises:

a first and a second coherent incident light beams, and wherein

the first incident light beam and the second incident light beam partially or completely overlap and interfere in the volume of recording material.

44. The process of clause 43, wherein

the first incident light beam is linearly polarized, and

the second incident light beam is linearly polarized and a polarization direction of the first incident light beam is parallel to a polarization direction of the second incident light beam.

45. The process of clause 43, wherein

the first incident light beam is linearly polarized, and

the second incident light beam is linearly polarized and a polarization direction of the first incident light beam is perpendicular to a polarization direction of the second incident light beam.

46. The process of clause 43, wherein

the first incident light beam is circularly polarized, and

the second incident light beam is circularly polarized in the same direction.

47. The process of clause 43, wherein the first incident light beam is circularly polarized in a first direction, and the second incident light beam is circularly polarized in the opposite (orthogonal) direction.

48. A process for direct writing a volume hologram comprising a focused beam of light providing bitwise optical recording in the recording material of any one of clauses 1 to 41, the process comprising scanning the beam or the material and changing the intensity and/or polarization of the recording light.

49. The process of any one of clauses 42 to 48, wherein cross-linking photosensitive groups results in formation of a cyclobutane moiety of Formula A or Formula B:

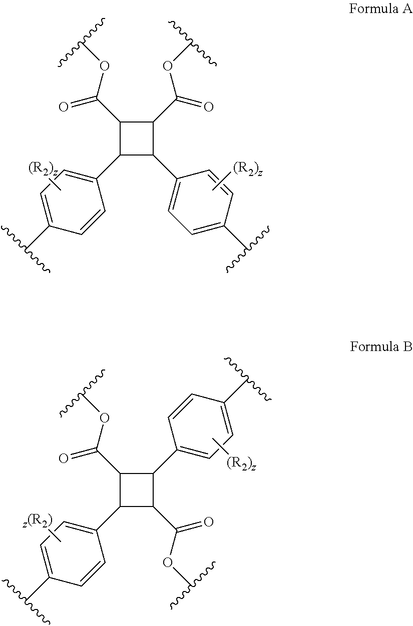

wherein in Formulas A and B:

z is independently at each occurrence 0, 1, 2, 3, or 4;

R₂ is independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and

R^{a} and R^{b} are independently selected from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

50. A volume hologram comprising a material of any one of clauses 1 to 41.

51. A volume hologram prepared by a process of any one of clauses 42 to 49.

52. An optical element comprising one or more holograms of clause 50 or clause 51.

What is claimed is:

1. A recording material for forming a volume hologram, wherein the recording material is characterized by a thickness and comprises a compound comprising a moiety of Formula 1 or Formula 2: 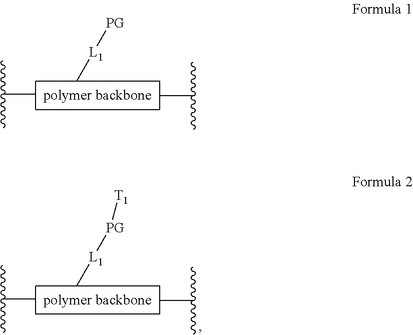
wherein the moiety of Formula 1 or Formula 2 comprises a polymer backbone, a side chain comprising a linker L₁ and a photosensitive group PG;
wherein T₁ in Formula 2 is a terminal group; and
wherein the photosensitive group or the terminal group comprises a cycloaddition precursor (CAP).

2. The recording material of claim 1, wherein the linker L₁ comprises one or more of a single bond, a double bond, a triple bond, a carbonyl group, a carboxyl group, a methylene group, an ether group, and an optionally substituted phenylene group, and wherein the terminal group T₁ comprises one or more of a single bond, a double bond, a triple bond, an optionally substituted phenylene group, a carbonyl group, a carboxyl group, a methylene group, an ether group, —H, —OH, —CH₃, —N(CH₃)₂, —C₂H₅, —C₃H₇, —CN, —NO₂, —OCH₃, —OC₂H₅, and —OC₃H₇.

3. The recording material of claim 1, wherein the polymer backbone comprises one or more of a polysiloxane fragment, a polymethylmethacrylate (PMMA) fragment, a polyacrylate fragment, a polymethacrylate fragment, a cellulose fragment, a polyvinyl fragment, a polyurethane fragment, a polyamic acid fragment, or a polyimide fragment.

4. The recording material of claim 1, wherein the side chain is of any one of Formulas 101 to 105: 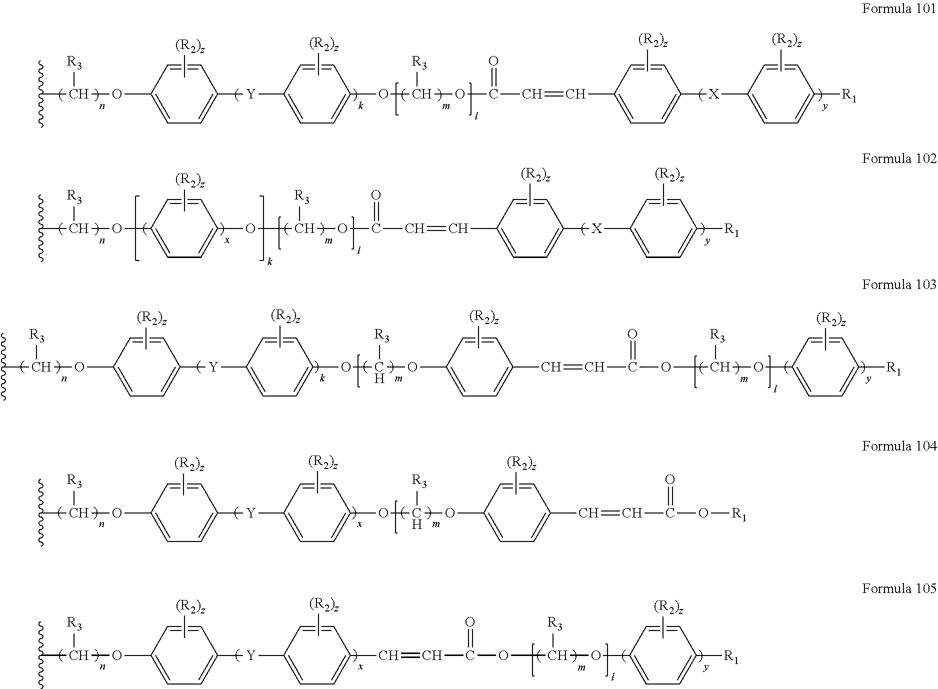
wherein in Formulas 101 to 105:
n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;
X and Y are independently selected from a single bond, a double bond, a triple bond, —C(O)—, —C(O)O—, —OC(O)—, and —C(O)NR^{a};
R₁ is independently selected from —H, —OH, —CH₃, —NR^{a}R^{b}, —C₂H₅, —C₃H₇, —CN, —NO₂, —OCH₃, —OC₂H₅, and —OC₃H₇;
R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and
R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

5. The recording material of claim 1, wherein the side chain is of any one of Formulas 106 to 117: 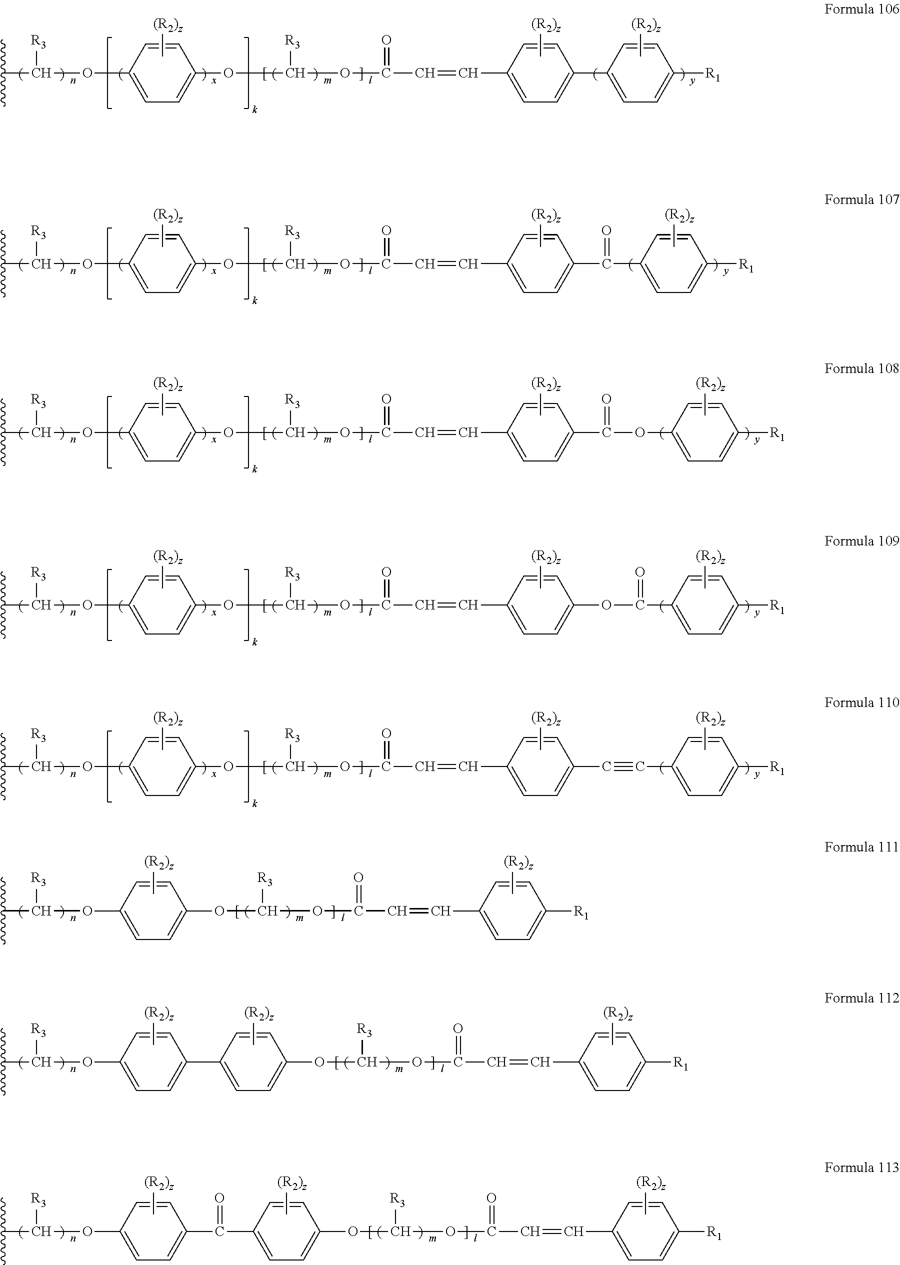 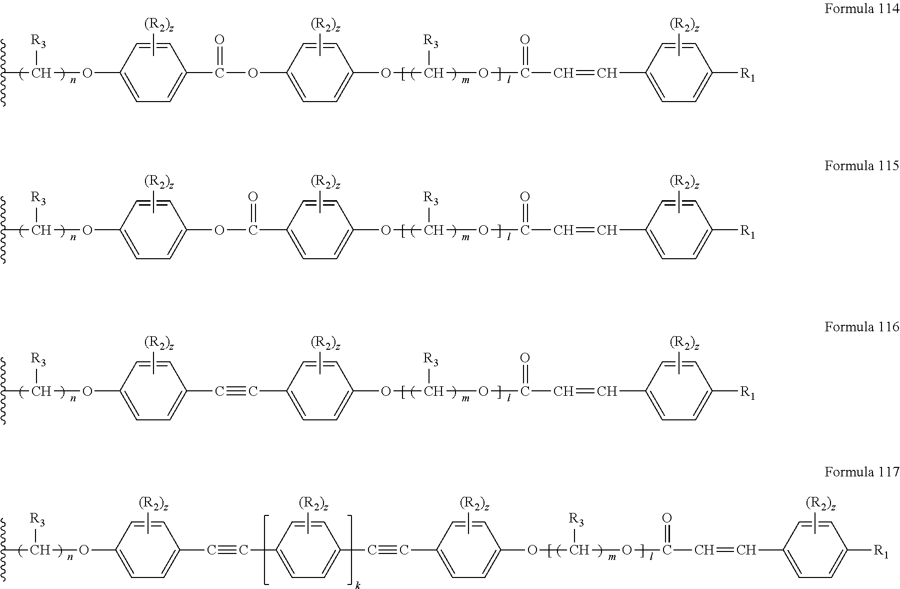
wherein in Formulas 106 to 117:
n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;
R₁ is independently selected from —H, —OH, —CH₃, —NR^{a}R^{b}, —C₂H₅, —C₃H₇, —CN, —NO₂, —OCH₃, —OC₂H₅, and —OC₃H₇;
R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and
R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

6. The recording material of claim 1, wherein the side chain is of any one of Formulas 118 to 123: 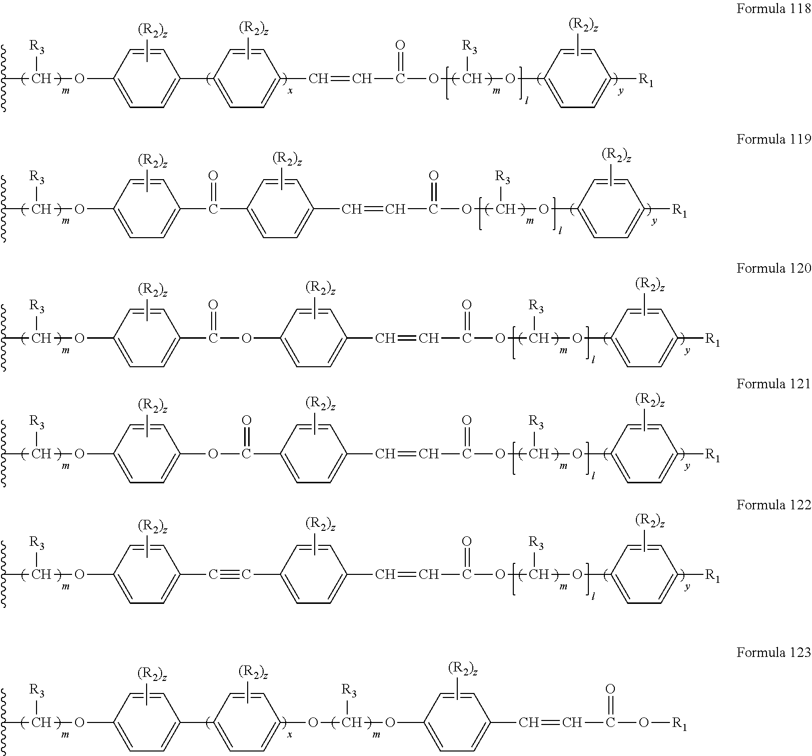
wherein in Formulas 118 to 123:
n is independently an integer from 0 to 12, m is independently an integer from 1 to 6, k is independently 0 or 1, l is independently 0 or 1, x is independently 0 or 1, y is independently 0 or 1, and z is independently at each occurrence 0, 1, 2, 3, or 4;
R₁ is independently selected from —H, —OH, —CH₃, —NR^{a}R^{b}, —C₂H₅, —C₃H₇, —CN, —NO₂, —OCH₃, —OC₂H₅, and —OC₃H₇;
R₂ and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and
R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

7. The recording material of claim 1, wherein the side chain is of any one of Formulas 124 to 131: 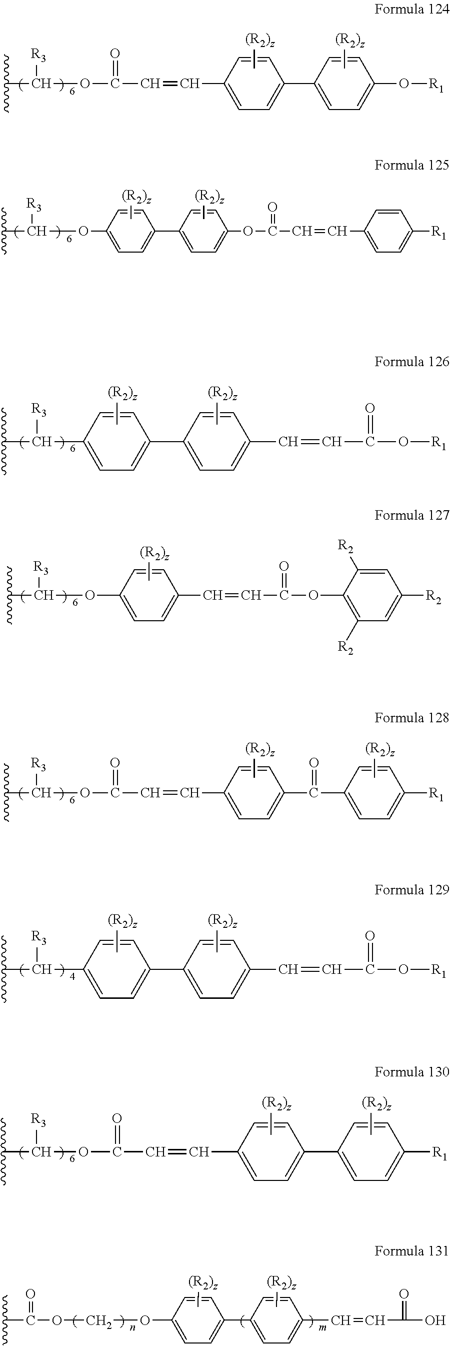
wherein in Formulas 124 to 131:
z is independently at each occurrence 0, 1, 2, 3, or 4, n is independently an integer from 0 to 12, and m is independently 0 or 1;
R₁, R₂, and R₃ are independently selected at each occurrence from hydrogen, alkyl, heteroalkyl, alkenyl, alkynyl, cycloalkyl, heterocycloalkyl, aryl, arylalkyl, heteroaryl, heteroarylalkyl, hydroxy, halo, cyano, fluoroalkyl, trifluoromethyl, trifluoromethoxy, nitro, trimethylsilanyl, —OR^{a}, —SR^{a}, —OC(O)R^{a}, —N(R^{a})R^{b}, —C(O)R^{a}, —C(O)OR^{a}, —OC(O)N(R^{a})R^{b}, —C(O)N(R^{a})R^{b}, —N(R^{a})C(O)OR^{a}, —N(R^{a})C(O)R^{a}, —N(R^{a})C(O)N(R^{a})R^{b}, —N(R^{a})C(NR^{a})N(R^{a})R^{b}, —N(R^{a})S(O)ₜR^{a}, —S(O)ₜOR^{a}, —S(O)ₜN(R^{a})R^{b}, —S(O)ₜN(R^{a})C(O)R^{b}, and —P(O)(OR^{a})(OR^{b}); and
R^{a} and R^{b} are independently selected at each occurrence from hydrogen, alkyl, fluoroalkyl, carbocyclyl, carbocyclylalkyl, aryl, aralkyl, heterocycloalkyl, heterocycloalkylalkyl, heteroaryl, and heteroarylalkyl.

8. The recording material of claim 1, wherein the side chain is of any one of Formulas 1001 to 1011:

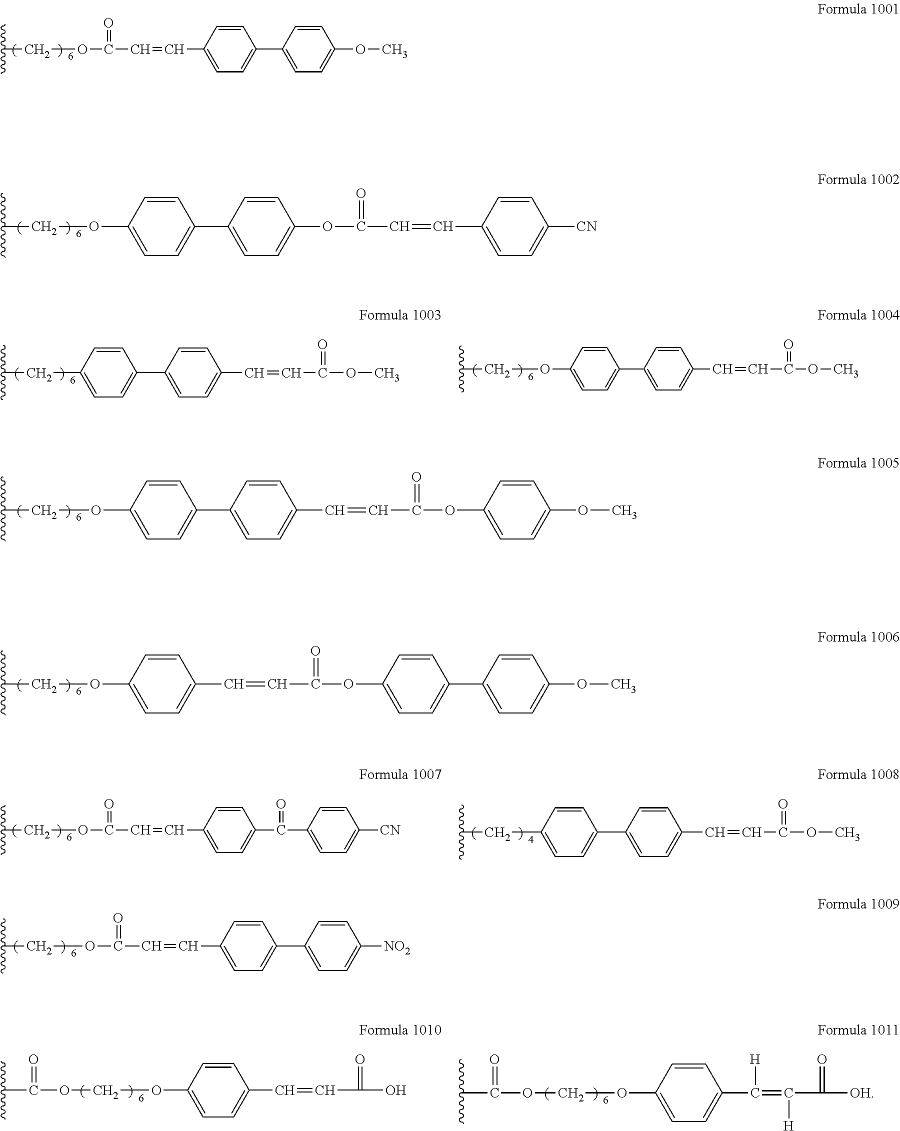

9. The recording material of claim 1, wherein the moiety of Formula 1 or Formula 2 is of any one of Formulas 2001 to 2014:

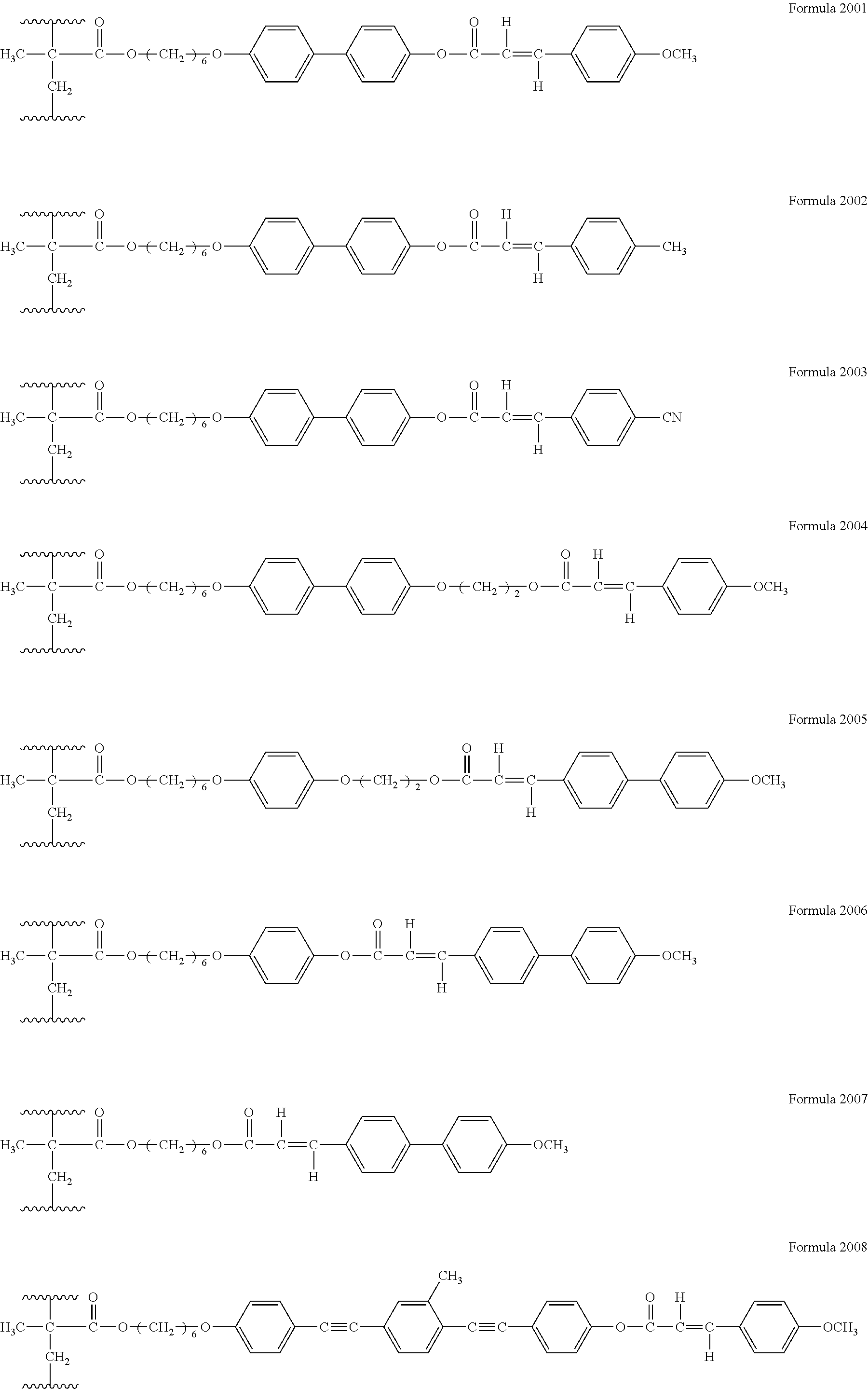

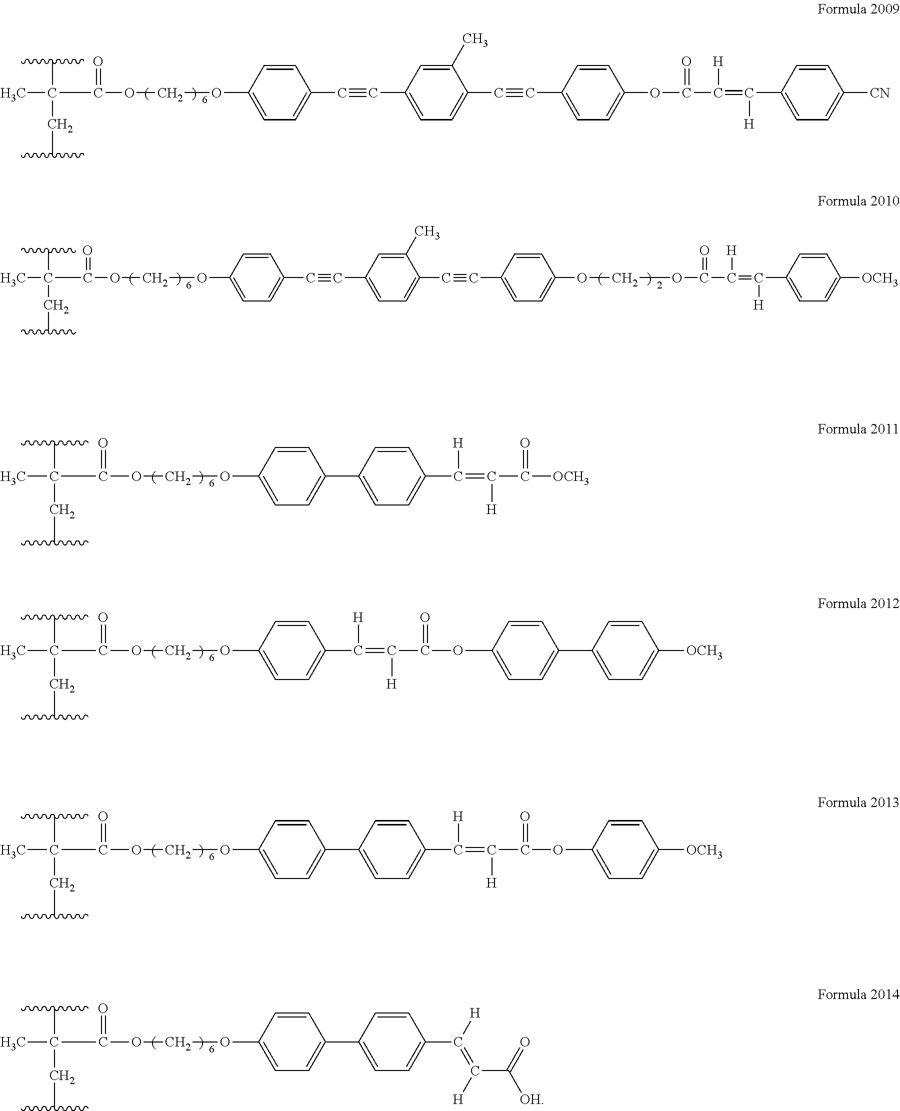

10. The recording material of claim 1, wherein the thickness of the recording material is between 0.5 m and 500 μm.

11. The recording material of claim 1, wherein the compound is a liquid crystal polymer.

12. The recording material of claim 1, wherein the compound is an amorphous polymer.

13. The recording material of claim 1, wherein the compound is optically aligned.

14. The recording material of claim 1, wherein the material is characterized by optically induced birefringence.

15. The recording material of claim 1, wherein the compound is optically transparent to visible light.

16. The recording material of claim 1, the material comprising a volume grating recorded in the recording material, wherein the volume grating is characterized by a Q parameter that is equal to or greater than 1, wherein
$$Q = \frac{2 π λ d}{n {Λ}^{2}}$$
wherein,
λ is a wavelength of diffracting light,
d is the thickness of the recording material,
n is an average refractive index of the recording material for wavelength λ, and
Λ is a grating period (fringe spacing).

17. The recording material of claim 16, wherein Q is equal to or greater than 5.

18. The recording material of claim 16, wherein Q is equal to or greater than 10.

19. A composite film for recording a volume hologram comprising the recording material of claim 1 and a substrate film.

20. The composite film of claim 19, wherein the substrate film comprises one or more of polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulphone, cellulose triacetate (CTA), polyamide, polymethyl methacrylate, polyvinyl chloride, polyvinyl butyral, polydicyclopentadiene, or a combination thereof.
